(19) United States
(12) Patent Application Publication
(10) Pub. No.: US 2024/0050784 A1
(43) Pub. Date: Feb. 15, 2024

(54) REUSABLE, FLEXIBLE HALF FACEMASKS, FACEMASK KITS, AND METHODS OF ASSEMBLING SAME

(71) Applicant: Sleepnet Corporation, Hampton, NH (US)

(72) Inventors: Jerry Gong, Andover, MA (US); Robert Skaff, Hampton, NH (US)

(21) Appl. No.: 18/447,498

(22) Filed: Aug. 10, 2023

Related U.S. Application Data
(60) Provisional application No. 63/397,131, filed on Aug. 11, 2022.

(51) Int. Cl. A62B 18/08; A62B 23/02; A62B 19/00; A62B 18/10; A41D 13/11; B01D 46/00; B01D 46/24

(52) U.S. Cl. CPC A62B 18/08; A62B 23/02; A62B 19/00; A62B 18/10; A41D 13/1107; B01D 46/0005; B01D 46/2411; B01D 2265/06; B01D 2265/04; B01D 2271/02; B01D 2279/40

(57) ABSTRACT

Facemask cushions configured for perimeter sealing above the mentolabial crease and surface sealing below the mentolabial crease and under the chin are provided. Facemasks, facemask kits, and methods of assembling facemasks are also provided. In some instances, the facemask may be a reusable, flexible half facemask.

### RELATED APPLICATION

The present application claims the benefit under 35 U.S.C. § 119(e) to U.S. Provisional Application No. 63/397,131 filed on Aug. 11, 2022, the contents of which are incorporated by reference herein in their entirety.

### BACKGROUND

Reusable half facemasks may achieve seal using an elastomeric sealing surface. Elastomeric masks have a rubber/elastic material that lays on the face with a triangular hole for the nose and mouth. The rubber/elastic material must cover a substantial portion of the surface of the face to maintain seal as a user performs tasks. The elastomeric mask surface stretches around the broad coverage area and compresses into the face (i.e., in the z dimension) when headgear tension is applied. The wide sealing surface is intended to maintain sealing areas around the nose and mouth, and support underneath the chin. The surface area is also intended to minimize outward leakage around the nose to minimize fogging of eyewear. These performance goals are to be achieved while at rest, working, talking, and performing vigorous tasks in a harsh environment. Prior to initial use in a work environment, each user must perform a fit test. Once completed, the user must use the mask as tested (e.g., size, headgear options, etc.) and must re-take a fit test annually to ensure weight changes and/or other factors have not affected fit.

The elastomeric mask generally is a half or full mask, uses a framed cartridge with a lock in place position, and various cartridges are used to protect against particulate, chemicals, or compounds in the air. A filter or filters in place of or in addition to a cartridge or cartridges is also acceptable. Fit testing can be done using qualitative fit testing for some applications, while other applications require a quantitative fit test.

When properly fit, the elastomeric mask maintains a good seal. When the elastomeric mask is the correct size, it allows the mask to stretch as the head and mouth move. A mask that is too small may not seal (or may “break”) during certain motions, while a mask that is too large may not seal around the nose, face, and/or under the chin under any circumstance. Under chin fit is essential as it provides an anchor point along with the nose. Masks that do not cover below the chin often receive scrutiny as they can be known to fall off the face unexpectedly. Artificial Intelligence (AI) camera systems sometimes use below the chin coverage to tell if a mask is being worn from certain angles. Headgear is used to maintain tension to keep the mask on the face.

Immediately after donning the mask and prior to entering a harsh environment, a user generally performs a negative pressure test by covering any filter media (e.g., with the user's hands) and inhaling. The mask should pull into the face at the time of inhaling if there is an adequate seal. While the negative pressure test shows a certain level of seal, the user is relying on this and the fit test results to ensure seal. Negative pressure tests without an initial and annual fit test are not suitable in determining the mask's ability to seal when worn by the user.

Once the user passes a fit test, it has been generally understood that the mask can maintain a seal with simple breathing, movement, turning of the head and torso, bending at the waist, and talking assuming substantial chin movement. The fit test is approved for the specific mask make, model, size, and configuration of headgear, and other attributes that could alter performance. Recertification must be done annually to compensate for changes in the facial attributes that may change with weight gain/loss, water retention, or some other unforeseen factor. There can be no assumptions that the mask still fits because nothing has changed in weight or other factors from year to year.

While the elastomeric mask is generally a durable, effective solution, it requires a rubbery material to sit on a substantial portion of the face and anchor under the chin. This high level of skin contact can be uncomfortable, particularly for tasks that last several hours. Adding to this, the elastomeric mask uses headgear tension to form around the face, thereby adding to the discomfort. The wide surface area depends on very good facial contact, which also can easily be compromised with facial changes, particularly caused by a change in weight.

The soft surface of the elastomeric seal generally is connected to a harder surface. This surface often connects headgear and filtration media. Filtration media can be in the form of a filter(s), a cartridge(s), or both. The rigid area sits on top of the cushion, giving a levered effect of the weight due to its distance from the face, contributing further to the need for greater tension.

Gel quarter masks, such as the envo®mask (Sleepnet Corp., U.S.A.), and particularly those with non-elastomeric properties, simplify fit requirements. Quarter masks have significant fit advantages among a wide range of faces. Generally, quarter masks cover the nose and mouth by sealing an area from the nose down to the mentolabial crease or at the base of the chin, but not substantially below the chin. Because the nose and mouth are covered, the quarter mask provides an adequate sealing surface with less variation among users' faces. Some experts argue the effectiveness of a quarter mask is equivalent to that of a half mask, while others suggest a quarter mask is easier to come off the face during use. The industry defaults to an Assigned Protection Factor (APF) of 5 for a quarter mask and 10 for a half mask citing lack of data, and the desire to cover below the chin for additional anchoring and protection.

A full face continuous positive airway pressure (CPAP) mask covers areas similar to a quarter mask used in personal protection. A full face CPAP mask uses the mentolabial crease as a base, as compared to the chin, affording a cushion to remain on one plane and minimizing the levered effect experienced when the user opens its mouth. This allows for a sealing surface to go around the perimeter of the surface to be sealed as compared to a maximum contact approach as seen in the elastomeric context, the full face CPAP mask a more comfortable solution. The cushion can also have increased height, allowing for another surface to contour around the face, thereby making it a more universal fit.

When sealing below the chin, a new plane is introduced and greater movement from the chin as the mouth opens and closes is experienced. Sealing around a perimeter, while changing planes, has generally been done by using a substantial amount of coverage around the area, thereby adding weight and headgear tension and increasing the discomfort caused by the additional contact surface.

### SUMMARY

The present disclosure provides facemask cushions configured for perimeter sealing above the mentolabial crease and surface sealing below the mentolabial crease and under the chin. Facemask cushions of the present disclosure provide, among other things, a superior level of fit and comfort over other facemask cushions. Facemasks, facemask kits, and methods of assembling facemasks are provided. In some instances, a facemask of the present disclosure may be a reusable, flexible half facemask.

A first aspect of the present disclosure relates to a cushion of a facemask comprising: a perimeter sealing portion configured to make a perimeter seal above a mentolabial crease of a user; and a convex portion extending from a bottom portion of the cushion and partway to a top portion of the cushion, wherein the convex portion is configured to contact a user's chin, below the mentolabial crease, and facilitate a surface seal between the cushion and the user's face.

In some embodiments of the first aspect, the cushion further comprises a bottom portion configured to extend below the user's chin.

In some embodiments of the first aspect, the convex portion has a height of about 0.6 inches to about 0.9 inches.

In some embodiments of the first aspect, the convex portion has a vertical height that is a maximum of about 40% of the distance between bottom and top portions of the cushion. In some embodiments of the first aspect, the convex portion has a vertical height that is a maximum of about 20% of the distance between the bottom and top portions of the cushion.

In some embodiments of the first aspect, the convex portion has a vertical height that is a minimum of about 12% of the distance between bottom and top portions of the cushion.

In some embodiments of the first aspect, the convex portion has a vertical height that is a minimum of about 25% of the distance between the bottom and top portions of the cushion.

In some embodiments of the first aspect, the convex portion extends substantially parallel to a plane, formed from a cushion attachment surface of a mask body of a facemask, when the facemask is not in use.

In some embodiments of the first aspect, the convex portion is configured to bend and extend away from a plane, formed from a cushion attachment surface of a mask body of a facemask, when convex portion is acted upon by the user's chin, wherein the bending of the convex portion facilitates creation and maintenance of the surface seal between the cushion and the user's face.

In some embodiments of the first aspect, the convex portion is configured to bend up to perpendicular with respect to the plane.

In some embodiments of the first aspect, the convex portion extends substantially parallel to a cross-section of a flexible rim, of a mask body of a facemask, when the facemask is not in use.

In some embodiments of the first aspect, the convex portion is configured to bend and extend away from parallel with respect to a cross-section of a flexible rim, of a mask body of a facemask, as the convex portion is acted upon by the user's chin, wherein the bending of the convex portion facilitates creation and maintenance of the surface seal between the cushion and the user's face.

In some embodiments of the first aspect, the convex portion is configured to bend up to perpendicular with respect to the cross-section of the flexible rim.

In some embodiments of the first aspect, the convex portion is configured to bend and extend toward a front of a mask body of a facemask as the convex portion is acted upon by the user's chin, wherein the bending of the convex portion facilitates creation and maintenance of the surface seal between the cushion and the user's face.

In some embodiments of the first aspect, the convex portion is configured to bend and extend into a cavity of a mask body of a facemask as the convex portion is acted upon by the user's chin, wherein the bending of the convex portion facilitates creation and maintenance of the surface seal between the cushion and the user's face.

A second aspect of the present disclosure relates to a facemask comprising: a mask body comprising a cushion attachment surface and a flexible rim, wherein the flexible rim extends inwardly away from the cushion attachment surface, and wherein the mask body is flexible and resilient; the cushion of the first aspect coupled to the cushion attachment surface; a filter; and a filter support structure coupled to the filter and the flexible rim, wherein the filter support structure is configured to engage the filter with the flexible rim to create an airtight seal between the filter and the flexible rim.

In some embodiments of the second aspect, the flexible rim is inwardly biased and the filter support structure is outwardly biased.

In some embodiments of the second aspect, the filter support structure comprises support elements.

In some embodiments of the second aspect, the support elements are configured as a lattice.

In some embodiments of the second aspect, the convex portion of the cushion facilitates the airtight seal, between the cushion and the user's face, when a length, from the user's chin to the bridge of the user's nose, is less than a length from the top to the bottom of the mask body.

In some embodiments of the second aspect, the filter comprises apertures and the filter support structure comprises extension elements, wherein the extension elements extend through the apertures to engage the filter against the filter support structure.

In some embodiments of the second aspect, each of the apertures is located proximate to a continuous perimeter edge of the filter.

In some embodiments of the second aspect, the extension elements extend outwardly through the apertures of the filter.

In some embodiments of the second aspect, the filter support structure comprises a continuous back perimeter and the extension elements extend outwardly from the continuous back perimeter.

In some embodiments of the second aspect, the continuous back perimeter forms a plane of the filter support element and the extension elements extend outwardly along the plane of the filter support element.

In some embodiments of the second aspect, the flexible rim comprises apertures and the extension elements extend through the apertures of the flexible rim after the extension elements extend through the apertures of the filter, thereby contacting the filter with the flexible rim to create the airtight seal between the filter and the flexible rim.

In some embodiments of the second aspect, the extension elements extend outwardly through the apertures of the flexible rim.

In some embodiments of the second aspect, the filter support structure has a convex surface configured for placement against and at least substantially corresponding to an inner concave surface of the filter.

In some embodiments of the second aspect, the filter is permanently coupled to the filter support structure and the airtight seal, between the filter and the flexible rim, is established by direct friction fitting the filter to the flexible rim.

In some embodiments of the second aspect, the filter is permanently coupled to the filter support structure using at least one of adhesion, welding, and crimping.

In some embodiments of the second aspect, an inner portion of the filter, proximate a perimeter edge of the filter, is permanently coupled to an outer surface of the filter support structure.

In some embodiments of the second aspect, the airtight seal, between the filter and the flexible rim, is further established by direct friction fitting the filter support structure to the flexible rim.

In some embodiments of the second aspect, the flexible rim is inwardly angled and biased and an external edge portion, of the filter, is outwardly biased and directly friction fit against an inner surface of the flexible rim.

In some embodiments of the second aspect, the filter support structure has a continuous channel, an o-ring secures a portion of the filter within the channel, and the airtight seal, between the filter and the flexible rim, is established by direct friction fitting the filter to the flexible rim.

In some embodiments of the second aspect, the airtight seal, between the filter and the flexible rim, is further established by direct friction fitting the filter support structure to the flexible rim.

In some embodiments of the second aspect, the flexible rim is inwardly angled and biased and an external edge portion, of the filter, is outwardly biased and directly friction fit against an inner surface of the flexible rim.

A third aspect of the present disclosure relates to a facemask comprising: a mask body comprising a cushion attachment surface and a flexible rim, wherein the flexible rim extends inwardly away from the cushion attachment surface, and wherein the mask body is flexible and resilient; the cushion of the first aspect coupled to the cushion attachment surface; at least one of a filter cartridge and a filter; and a housing removably coupled to the mask body via direct friction fitting that produces an airtight seal between the mask body and the housing, the housing comprising a filtration media coupler configured to removably receive and couple to the at least one of the filter cartridge and the filter.

In some embodiments of the third aspect, the flexible rim is inwardly angled and biased and an external edge portion, of the housing, is outwardly biased and directly friction fit against an inner surface of the flexible rim.

In some embodiments of the third aspect, the housing comprises an aperture configured to permit ingress and egress of air into and from a breathing chamber of the facemask.

In some embodiments of the third aspect, the housing comprises: a one-way value configured to permit air to ingress into a breathing chamber of the facemask via the at least one of the filter cartridge and the filter; and one or more one-way values configured to allow air to egress from the breathing chamber.

In some embodiments of the third aspect, the housing comprises a port configured to permit ingress, and optionally egress, of air into, and optionally from, a breathing chamber of the facemask; the facemask comprises both the filter cartridge and the filter; and the filter is positioned within the filtration media coupler between the filter cartridge and the port.

In some embodiments of the third aspect, the facemask further comprises a filter holder positioned between the filter and the port.

In some embodiments of the third aspect, the housing comprises a port configured to permit ingress, and optionally egress, of air into, and optionally from, a breathing chamber of the facemask; the facemask comprises the filter but the filter cartridge; and the facemask further comprises a filter retaining element removably coupled to the filtration media coupler, wherein the filter is positioned within the filtration media coupler between the filter retaining element and the port.

In some embodiments of the third aspect, the facemask further comprises a filter holder positioned between the filter and the port.

A fourth aspect of the present disclosure relates to a kit comprising: a mask body comprising a cushion attachment surface and a flexible rim, wherein the mask body is flexible and resilient, the flexible rim extends inwardly away from the cushion attachment surface, the flexible rim has apertures, the mask body has the cushion of claim 1 coupled to the cushion attachment surface; a filter having apertures; and a filter support structure having extension elements and configured to be removably coupled to the filter and the flexible rim by: extending the extension elements through the apertures of the filter, thereby removably coupling the filter to the filter support structure; and after extending the extension elements through the apertures of the filter, extending the extension elements through the apertures of the flexible rim, thereby engaging the filter with the flexible rim to create an airtight seal between the filter and the flexible rim.

In some embodiments of the fourth aspect, the flexible rim is inwardly biased and the filter support structure is outwardly biased.

In some embodiments of the fourth aspect, the filter support structure comprises support elements.

In some embodiments of the fourth aspect, the support elements are configured as a lattice.

In some embodiments of the fourth aspect, each of the apertures of the filter is located proximate to a continuous perimeter edge of the filter.

In some embodiments of the fourth aspect, the extension elements are configured to extend outwardly through the apertures of the filter.

In some embodiments of the fourth aspect, the filter support structure comprises a continuous back perimeter and the extension elements extend outwardly from the continuous back perimeter.

In some embodiments of the fourth aspect, the continuous back perimeter forms a plane of the filter support structure and the extension elements extend outwardly along the plane of the filter support structure.

In some embodiments of the fourth aspect, the extension elements are configured to extend outwardly through the apertures of the flexible rim.

In some embodiments of the fourth aspect, the filter support structure has a convex surface configured for placement against and at least substantially corresponding to an inner concave surface of the filter.

A fifth aspect of the present disclosure relates to a method of assembling a facemask, the method comprising: obtaining a mask body comprising a cushion attachment surface and a flexible rim, wherein the mask body is flexible and resilient, the flexible rim extends inwardly away from the cushion attachment surface, the flexible rim has apertures, the mask body has the cushion of the first aspect coupled to the cushion attachment surface; obtaining a filter having apertures; obtaining a filter support structure having extension elements; preparing a filter assembly by removably coupling the filter to the filter support structure by extending the extension elements through the apertures of the filter; and removably coupling the filter assembly to the mask body by extending the extension elements through the apertures of the flexible rim, thereby creating an airtight seal between the filter and the flexible rim.

A sixth aspect of the present disclosure relates to a kit comprising: a mask body comprising a cushion attachment surface and a flexible rim, wherein the mask body is flexible and resilient, the flexible rim extends inwardly away from the cushion attachment surface, the mask body has the cushion of claim 1 coupled to the cushion attachment surface; and a filter assembly comprising a filter permanently coupled to a filter support structure, wherein the filter assembly is configured to removably couple the filter to the flexible rim by direct friction fitting the filter against the flexible rim, thereby engaging the filter with the flexible rim to create an airtight seal between the filter and the flexible rim.

In some embodiments of the sixth aspect, the flexible rim is inwardly biased and the filter support structure is outwardly biased.

In some embodiments of the sixth aspect, the filter support structure has a convex surface placed against and at least substantially corresponding to an inner concave surface of the filter. In some embodiments of the sixth aspect, the filter is permanently coupled to the filter support structure using at least one of adhesion, welding, and crimping.

In some embodiments of the sixth aspect, an inner portion of the filter, proximate a perimeter edge of the filter, is permanently coupled to an outer surface of the filter support structure.

In some embodiments of the sixth aspect, the airtight seal, between the filter and the flexible rim, is further established by direct friction fitting the filter support structure to the flexible rim.

In some embodiments of the sixth aspect, the flexible rim is inwardly angled and biased and an external edge portion, of the filter, is outwardly biased and directly friction fit against an inner surface of the flexible rim.

A seventh aspect of the present disclosure relates to a method of assembling a facemask, the method comprising: obtaining a mask body comprising a cushion attachment surface and a flexible rim, wherein the mask body is flexible and resilient, the flexible rim extends inwardly away from the cushion attachment surface, the mask body has the cushion of claim 1 coupled to the cushion attachment surface; obtaining a filter assembly comprising a filter permanently coupled to a filter support structure; and removably coupling the filter assembly to the mask body by direct friction fitting the filter against the flexible rim, thereby engaging the filter with the flexible rim to create an airtight seal between the filter and the flexible rim.

In some embodiments of the seventh aspect, an inner portion of the filter, proximate a perimeter edge of the filter, is permanently coupled to an outer surface of the filter support structure.

In some embodiments of the seventh aspect, removably coupling the filter assembly to the mask body further comprises direct friction fitting the filter support structure to the flexible rim.

In some embodiments of the seventh aspect, the flexible rim is inwardly angled and biased; an external edge portion, of the filter, is outwardly biased; and removably coupling the filter assembly to the mask body comprises directly friction fitting the external edge portion, of the filter, against an inner surface of the flexible rim.

### BRIEF DESCRIPTION OF DRAWINGS

For a more complete understanding of the present disclosure, reference is now made to the following description taken in conjunction with the accompanying drawings.

FIG. 1a is a front planar view of a mask body.

FIG. 1b is a side view of the mask body of FIG. 1a.

FIG. 1c is a back planar view of the mask body of FIGS. 1a and 1b.

FIG. 2a is a front planar view of the mask body, of FIGS. 1a through 1c, having a cushion coupled thereto.

FIG. 2b is a back planar view of the mask body and cushion assembly of FIG. 2a.

FIG. 3 is a front view of the mask shell and cushion assembly, of FIGS. 2a and 2b, coupled to a user's face using headgear.

FIG. 4a is an elevated bottom view of the mask body and cushion assembly, of FIGS. 2a and 2b, with a convex portion of the cushion in an unbent state.

FIG. 4b is an elevated bottom view of the mask body and cushion assembly, of FIG. 4a, with the convex portion of the cushion in a bent state.

FIG. 4c is a side view of the mask body and cushion assembly of FIG. 4b, illustrating the convex portion of the cushion in the bent state.

FIG. 5 is a front planar view of the mask body and cushion assembly of FIG. 2a, with dashed lines illustrating an extended fitting area caused by the transition from a perimeter sealing portion of the cushion to the surface-sealing convex portion of the cushion.

FIG. 6a is a front planar view of a filter support structure.

FIG. 6b is a back planar view of the filter support structure of FIG. 6a.

FIG. 7 is a side view of a mask shell, cushion, and filter support structure assembly coupled to a user's face using headgear.

FIG. 8a is a front planar view of a filter.

FIG. 8b is a back planar view of the filter of FIG. 8a.

FIG. 9a is a front planar view of a filter including a respirator valve.

FIG. 9b is a back planar view of the filter of FIG. 9a.

FIG. 10 is a side view of a facemask coupled to a user's face using headgear, where the mask body couples to the filter support structure and filter without using extension elements.

FIG. 11 is a side cross-section view of the facemask of FIG. 10.

FIG. 12 is an exploded side cross-section view of a facemask.

FIG. 13 is a flow chart of a method of assembling a facemask.

FIG. 14 is a flow chart of a method of assembling a facemask.

FIG. 15 is a flow chart of a method of assembling a facemask.

FIG. 16 is a front view of plastic faces showing seals produced using a fluid-filled cushion, of the present disclosure, and an elastomeric mask.

FIG. 17 is a side view of the plastic faces showing the seals produced using the fluid-filled cushion, of the present disclosure, and the elastomeric mask.

FIG. 18a is a front planar view of a mask body and housing of a facemask.

FIG. 18b is a back planar view of the mask body and housing of the facemask of FIG. 18a with a cushion.

FIG. 19a is a front planar view of the mask body and housing of FIGS. 18a and 18b with a filter cartridge.

FIG. 19b is a side view of the mask body, housing, and filter cartridge of FIG. 19a.

FIG. 19c is a perspective view of the mask body, housing, and filter cartridge of FIG. 19a with the cartridge illustrated in phantom.

FIG. 19d is an exploded perspective view of the mask body, housing, and filter cartridge of FIG. 19a.

FIG. 19e is an exploded perspective view of the mask body, housing, and filter cartridge of FIG. 19a with a filter and filter holder.

FIG. 20a is a front planar view of the mask body and housing of the facemask of FIGS. 18a and 18b with a filter.

FIG. 20b is a front planar view of the mask body, housing, and filter of FIG. 20a with a filter retaining element.

FIG. 20c is an exploded perspective view of the mask body, housing, filter, and filter retaining element of FIG. 20b.

### DETAILED DESCRIPTION

The present disclosure relates to reusable, flexible half facemasks that, among other things, achieve an airtight seal with a user's face while having less contact surface area than a traditional elastomeric half mask, thereby improving user comfort. As used herein, an “airtight seal” between components of a facemask and between a user and a cushion of a facemask can refer to either a seal in which air is incapable of passing or a seal that is greater in air resistance than the air resistance of the facemask filter, such that inhalation and exhalation of the user results in substantially or all air that enters and exits the breathing chamber of the facemask passing through the facemask filter.

The present disclosure sets forth various components of (half) facemasks. The skilled person will appreciate that individual components, and/or component assemblies, may provide utility aside from a completely assembled facemask described herein. In other words, the skilled person will appreciate that facemask components and component assemblies described herein may provide utility to facemask configurations not explicitly disclosed herein.

### Mask Body

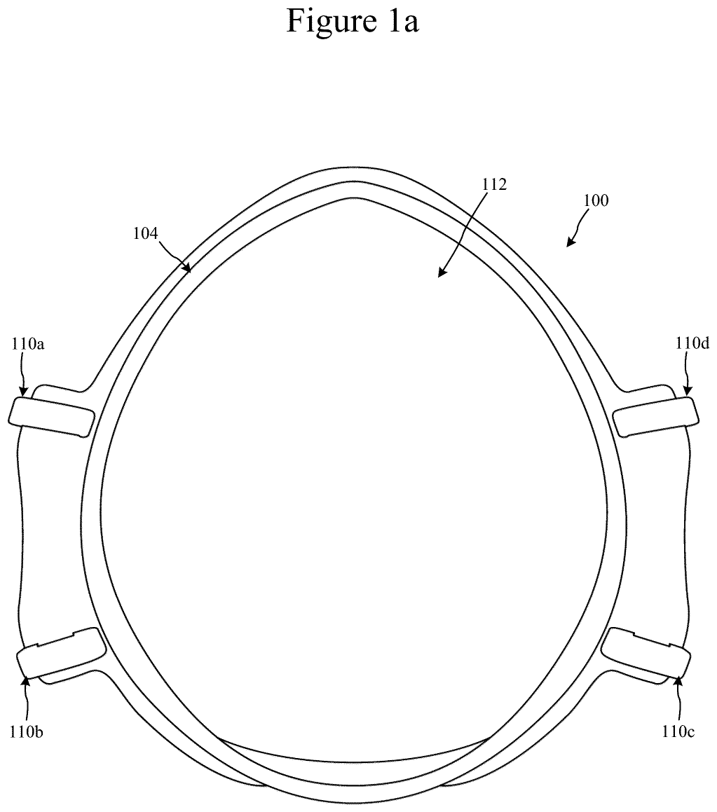

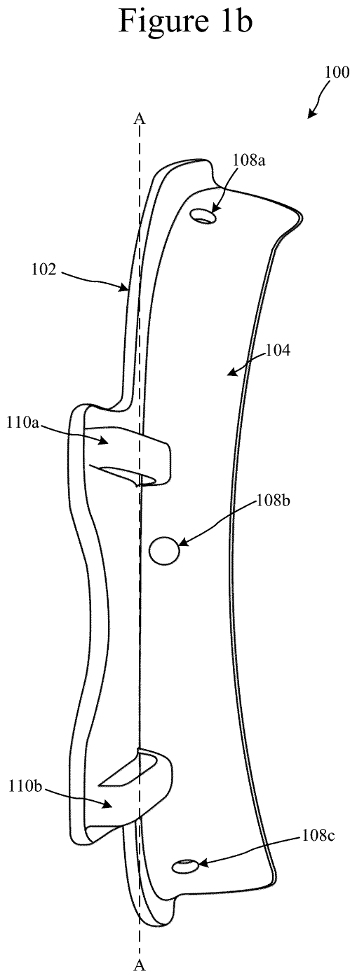

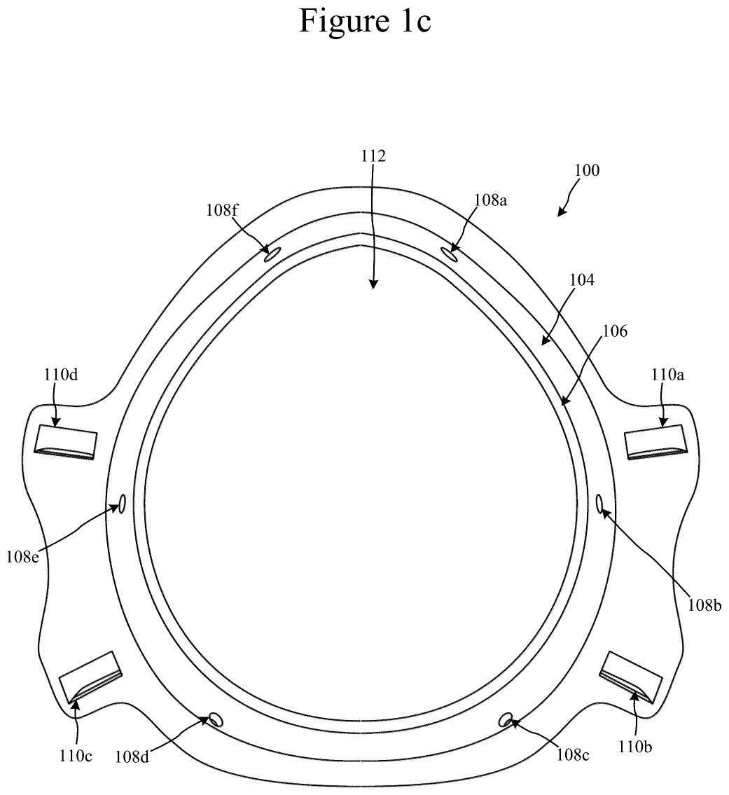

FIGS. 1a through 1c illustrated an example mask body 100 that may form part of a facemask.

In some embodiments, the entirety of the mask body 100 is formed from a flexible material capable of bending when headgear tension is applied but sturdy enough to accept a filter assembly prior to headgear tension. In some embodiments, the flexible material may be a malleable plastic. In some embodiments, the malleable plastic may be polyvinyl chloride (PVC).

The flexible nature of the mask body 100 may enable an arc of the mask body to vary as a result of being pressed against the user's face using tension of headgear, thereby enabling the mask body 100 to adjust for faces of different widths and other minor facial variations (e.g., cheekbone structure, water retention, bridge of nose, cleft chin, etc.).

In some embodiments, the mask body 100 is resilient, meaning the mask body 100 is configured to recoil or spring back into a “resting” configuration after being bent, stretched, and/or compressed.

The mask body 100 includes a cushion attachment surface 102 (illustrated in FIG. 1b) to which a cushion may be removably or permanently coupled. In some embodiments, a cushion may be permanently adhered (e.g., using glue or another adhesive) to the cushion attachment surface 102.

The cushion attachment surface 102 forms a back surface of the mask body 100. In some embodiments, the cushion attachment surface 102 forms a plane A-A of the mask body 100.

The mask body 100 includes a flexible rim 104. The flexible rim 104 extends away from the cushion attachment surface 102. In other words, the flexible rim 104 extends away from the user's face when the mask body 100 is being worn by the user.

In some embodiments, the flexible rim 104 extends inwardly away from the cushion attachment surface 102. That is, the circumference and/or diameter of the cross-section of the flexible rim 104 decreases the further way the cross-section is from the cushion attachment surface 102.

In some embodiments, the flexible rim 104 may include a lip 106 (illustrated in FIG. 1c). The lip 106 may extend inwardly from the outer perimeter of the flexible rim 104, and assist in (e.g., provide an additional contact ridge) forming an airtight seal with a filter described in further detail herein below.

In the example of FIGS. 1a through 1c, the flexible rim 104 includes apertures 108 (illustrated in FIGS. 1b and 1c) for facilitating coupling of a filter assembly to the mask body 100. As illustrated in FIG. 1c, the flexible rim 104 may include six apertures 108 (i.e., a first aperture 108a, a second aperture 108b, a third aperture 108c, a fourth aperture 108d, a fifth aperture 108e, and a sixth aperture 108f). However, the skilled person will recognize that the six aperture embodiment of FIGS. 1a through 1c is illustrative, and that other numbers and positions of the apertures 108 are possible and within the scope of the present disclosure.

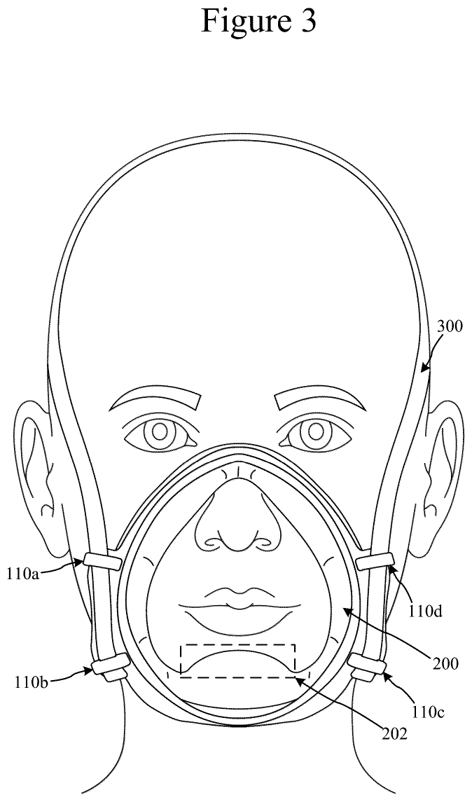

The mask body 100 includes two or more attachment points 110 (e.g., at least one attachment point 110 on each side of the mask body 100) for coupling the mask body 100 to headgear 300 (illustrated in FIG. 3). In the example of FIGS. 1a through 1c, the mask body 100 may include four attachment points 110 (i.e., a first attachment point 110a, a second attachment point 110b, a third attachment point 110c, and a fourth attachment point 110d). The skilled person will recognize that the four attachment point embodiment of FIGS. 1a through 1c is illustrative, and that other numbers and positions of the attachment points 110 are possible and within the scope of the present disclosure.

As illustrated in FIGS. 1a through 1c, the attachment points 110 may be loops through which headgear 300 can be positioned. Notwithstanding, the skilled person will appreciate that other types of attachment points (both presently known and not yet discovered) are possible and within the scope of the present disclosure. Moreover, the skilled person will appreciate that other types of headgear, than the headgear 300 illustrated in FIGS. 3, 7, and 14, are possible and within the scope of the present disclosure.

The mask body 100 is configured with a cavity 112 defined by an inner surface of the flexible rim 104. The dimensions of the cavity 112 are configurable based on face heights of users and/or air volume requirements for proper use. In the half facemask context, the cavity 112 may be sized to accommodate the user's nose and mouth.

### Cushions

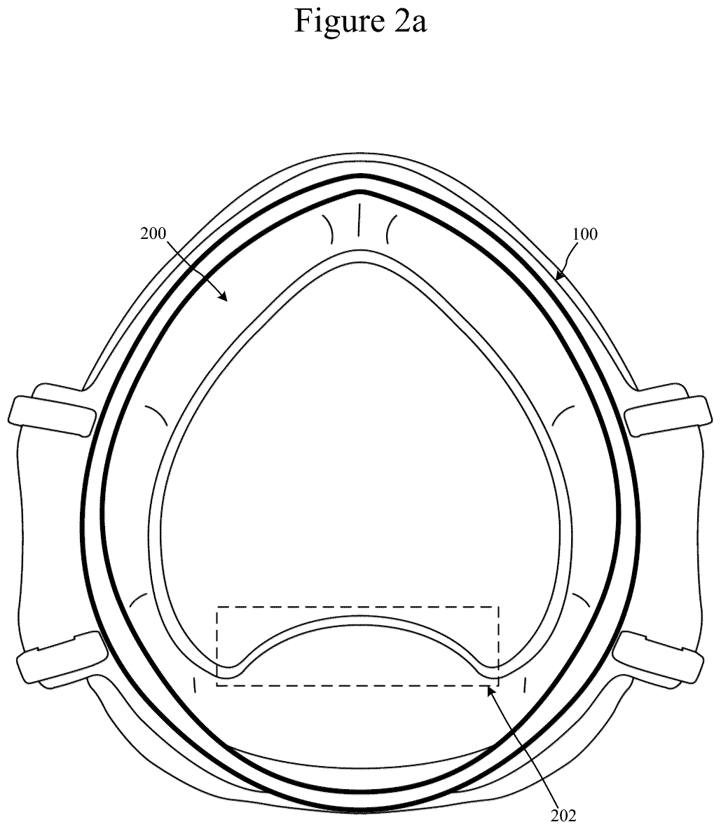

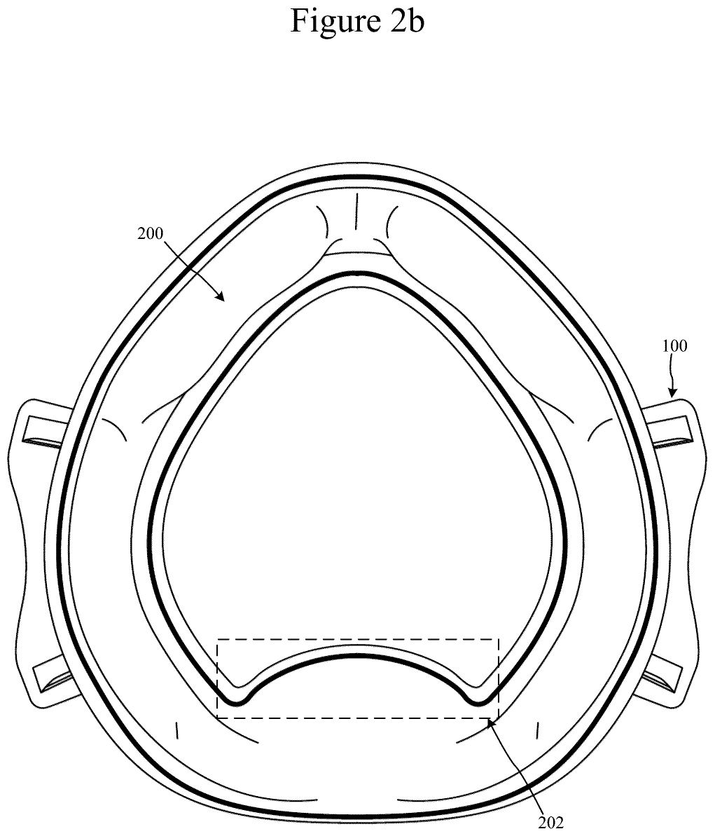

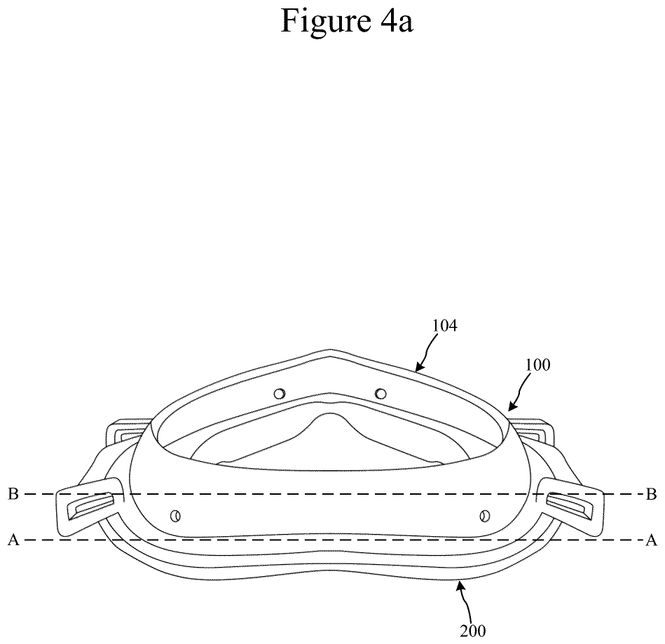

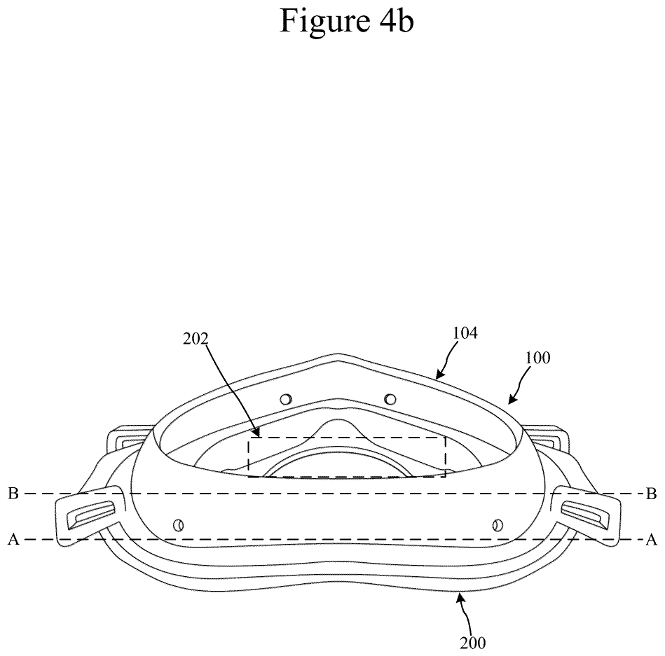

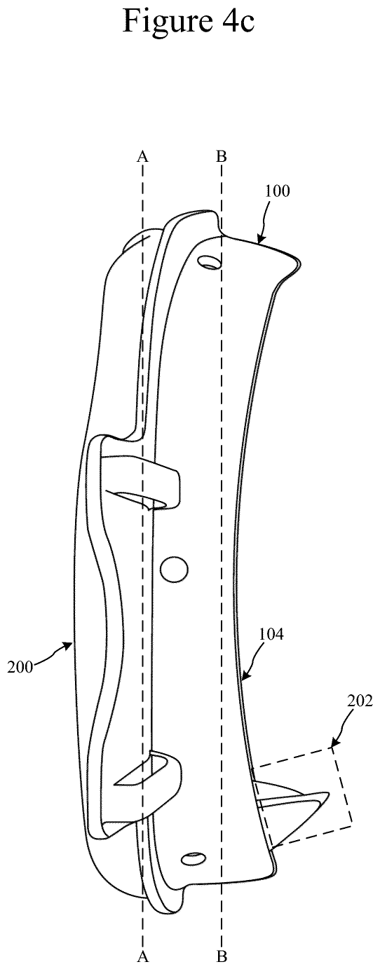

FIGS. 2a through 4c illustrate the mask body 100 having a cushion 200 coupled thereto. The cushion 200 may be removably or permanently coupled to the cushion attachment surface 102 of the mask body 100. In some embodiments, the cushion 200 may be permanently adhered (e.g., using glue or another adhesive) to the cushion attachment surface 102.

In the example where the facemask is a half mask (see the example of FIG. 3), the cushion 200 may be sized to maintain an airtight seal of an area from the user's nose down to below the user's chin (i.e., an area of the user's face below the mentolabial crease). In other words, the cushion 200 may include a bottom portion configured to extend below the user's chin.

The cushion 200 of the present disclosure may include a convex portion 202 that extends from a bottom portion of the cushion 200 and partway to a top portion of the cushion 200. The convex portion 202 is configured to contact the user's chin, thereby facilitating an airtight seal between the cushion 200 and the user's face (and more particularly an area of the user's face including and surrounding the user's chin).

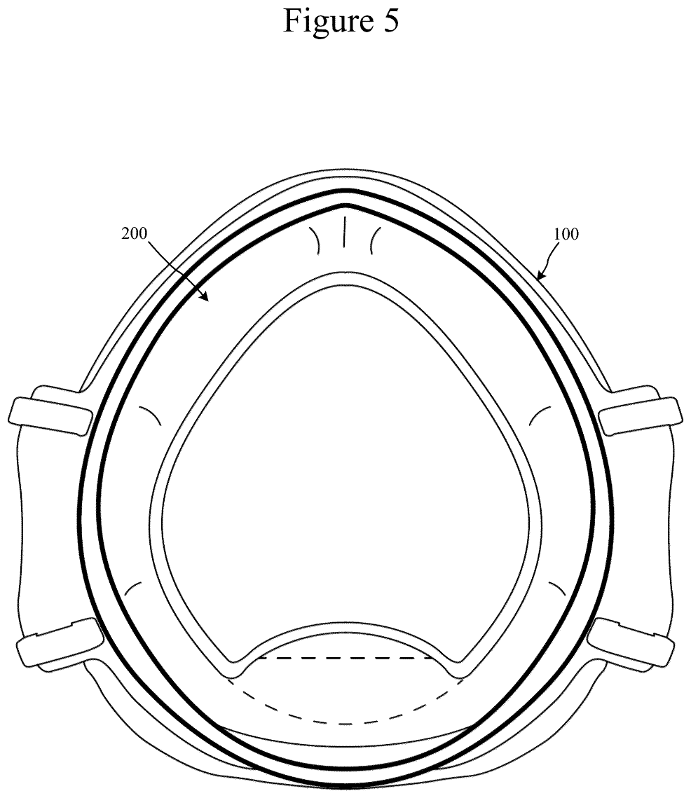

FIG. 5 is a front planar view of the mask body and cushion assembly of FIG. 2a, with dashed lines illustrating an extended fitting area caused by the transition from a perimeter sealing portion of the cushion (corresponding to the skin contacting portion of the cushion 200 save the convex portion 202) to the surface-sealing convex portion 202 of the cushion 200. The convex portion 202, of the cushion 200, results in an extended range for fitting smaller faces having bridge of nose to chin heights between the top and bottom dashed lines in FIG. 5.

When not in use, the perimeter sealing portion and the surface-sealing convex portion 202 of the cushion may extend along a first plane. However, when in use, the surface-sealing convex portion 202 may extend along a second plane that can be oriented 1° to about 90° with respect to the first plane. As such, the perimeter sealing portion may establish a perimeter seal along the first plane above the mentolabial crease of the user while the surface-sealing convex portion 202 may establish a surface seal along the second plane below the user's mentolabial crease.

In some instances, the cross-section of the perimeter seal may be less than the cross-section of the surface seal. The cross-section of the surface seal may increase the more the surface-sealing convex portion 202 is acted upon by the user's face. In other words, the greater the angle between the first plane of the perimeter seal and the second plane of the surface seal, the greater the cross-section of the surface seal may be.

The height of the convex portion 202 may vary among cushion sizes. In some embodiments, the height of the convex portion 202 may be about 0.6 inches to about 0.9 inches. This height configuration of the convex portion 202 increases a fitting range of user faces by about 0.65 inches to about 0.75 inches. While this may appear to be small, this dimension range is a substantial percentage of the dimensions from the bridge of the nose to below the chin of various users. The skilled person would not expect an elastomeric mask to stretch in the Y dimension more than 0.1-0.2 inches, and the elastomeric mask cannot compress in the Y dimension.

In some embodiments, the vertical height of the convex portion 202 (as marked by the dashed box in FIGS. 2a and 2b) may be a maximum of about 20% of the distance between the bottom and top portions of the cushion 200.

In some embodiments, the vertical height of the convex portion 202 (as marked by the dashed box in FIGS. 2a and 2b) may be a minimum of about 12% of the distance between the bottom and top portions of the cushion 200.

In some embodiments, the vertical height of the convex portion 202 (as marked by the dashed box in FIGS. 2a and 2b) may be from about 12% to about 20% of the distance between the bottom and top portions of the cushion 200. The vertical height of the convex portion 202 may be about 12%, about 13%, about 14%, about 15%, about 16%, about 17%, about 18%, about 19%, or about 20% of the distance between the bottom and top portions of the cushion 200.

In some embodiments, the vertical height of the convex portion 202 (as marked by the dashed box in FIGS. 2a and 2b) may be a maximum of about 40% of the distance between the bottom and top portions of the cushion 200.

In some embodiments, the vertical height of the convex portion 202 (as marked by the dashed box in FIGS. 2a and 2b) may be a minimum of about 25% of the distance between the bottom and top portions of the cushion 200.

In some embodiments, the vertical height of the convex portion 202 (as marked by the dashed box in FIGS. 2a and 2b) may be from about 25% to about 40% of the distance between the bottom and top portions of the cushion 200. The vertical height of the convex portion 202 may be about 25%, about 26%, about 27%, about 28%, about 29%, about 30%, about 31%, about 32%, about 33%, about 34%, about 35%, about 36%, about 37%, about 38%, about 39%, or about 40% of the distance between the bottom and top portions of the cushion 200.

In FIG. 5, the bottom arched dashed line represents a potential bottom impression of the user's chin against the convex portion 202, and the top dashed line represents a potential top-most impression location of the user's chin against the convex portion 202 while still maintaining an airtight seal between the convex portion 202 and the user's chin. This range of impression points may be equivalent to about 90% to about 95% of the vertical height of the convex portion 202 (as marked by the dashed box in FIGS. 2a and 2b).

In some embodiments, the convex portion 202 may be extend substantially or entirely parallel to the plane A-A of the mask body 100 when the facemask is not in use. When the facemask is in use, the convex portion 202 is configured to bend and extend away from the plane A-A as the convex portion 202 is acted upon by the user's chin. This bending of the convex portion 202 facilitates creation and/or maintenance of an airtight seal between the cushion 200 and the user's face.

In some embodiments, the convex portion 202 is configured to bend up to perpendicular with respect to the plane A-A of the mask body. For example, the convex portion 202 may be configured to bend up to 5°, 10°, 15°, 20°, 25°, 30°, 35°, 40°, 45°, 50°, 55°, 60°, 65°, 70°, 75°, 80°, 85°, or 90° with respect to the plane A-A.

In some embodiments, the convex portion 202 may extend substantially or entirely parallel to a cross-section B-B of the flexible rim 104 when the facemask is not in use. When the facemask is in use, the convex portion 202 is configured to bend and extend away from parallel, with respect to the cross-section B-B, as the convex portion 202 is acted upon by the user's chin. This bending of the convex portion 202 facilitates creation and/or maintenance of an airtight seal between the cushion 200 and the user's face.

In some embodiments, the convex portion 202 is configured to bend up to perpendicular with respect to the cross-section B-B of the flexible rim 104. For example, the convex portion 202 may be configured to bend up to 5°, 10°, 15°, 20°, 25°, 30°, 35°, 40°, 45°, 50°, 55°, 60°, 65°, 70°, 75°, 80°, 85°, or 90° with respect to the cross-section B-B.

In some embodiments, when the facemask is in use, the convex portion 202 is configured to bend and extend toward a front of the mask body 100 (i.e., a continuous perimeter edge of the flexible rim 104 located distal along the flexible rim 104 with respect to the cushion attachment surface 102) as the convex portion 202 is acted upon by the user's chin. This bending of the convex portion 202 facilitates creation and/or maintenance of an airtight seal between the cushion 200 and the user's face.

In some embodiments, when the facemask is in use, the convex portion 202 is configured to bend and extend into the cavity 112, of the mask body 100, as the convex portion 202 is acted upon by the user's chin. This bending of the convex portion 202 facilitates creation and/or maintenance of an airtight seal between the cushion 200 and the user's face.

In view of the foregoing disclosure with respect to the convex portion 202, the skilled person will appreciate that the convex portion 202 widens the range of fit of a facemask of the present disclosure for user faces whose dimensions from the chin to the bridge of the nose are shorter than a perimeter of the cushion 200. In other words, the convex portion 202 may facilitate an airtight seal, between the cushion 200 and the user's face, when a length, from the user's chin to the bridge of the user's nose, is less than a length from the top to the bottom of the mask body 100.

The cushion 200 may establish an airtight seal with respect to a first plane of the user's face (i.e., in line with the user's nose and mouth) until the convex portion 202 is reached, at which point the convex portion 202 establishes an airtight seal along a second plane of the user's face (i.e., below the chin and toward the neck). The convex portion 202 may become the primary sealing surface below the mentolabial crease and below the chin.

The cushion 200 can be comprised of one or more formed flexible materials having a durometer value of 60 or less on a Type 000 Shore scale, a durometer value of 50 or less on a Type 000 Shore scale, a durometer value of 40 or less on a Type 000 Shore scale, a durometer value of 30 or less on a Type 000 Shore scale, a durometer value of 20 or less on a Type 000 Shore scale, or a durometer value of 10 or less on a Type 000 Shore scale.

In some embodiments, the cushion 200 can be comprised of one or more formed flexible materials having a durometer value of about 60 to about 90 on Type 000 Shore scale. In some embodiments, the formed flexible materials may have a durometer value of about 60, about 65, about 70, about 75, about 80, about 85, or about 90 on the Type 000 Shore scale.

Example cushions of the present disclosure are silicone gel bladders, air-filled bladders, foam-filled bladders, and liquid rubber-filled bladders.

The Shore durometer is a device known to one of ordinary skill in the art for measuring the hardness of a material, typically of polymers, elastomers, and rubbers. Higher numbers on the scale indicate a greater resistance to indentation and thus harder materials. Lower numbers indicate less resistance and softer materials. The term is also used to describe a material's rating on the scale, as in an object having a “Shore durometer of 90.” Shore durometers are designed to measure specific scale ranges. A Type 000 durometer measures the hardness of very soft materials.

By configuring the cushion 200 to have a durometer value of 60 or less on a Type 000 Shore scale, the mask body 100 may contour to the user's face as it experiences tension from the headgear 300, and the cushion 200 may fill in the gaps not accommodated by pure contouring of the mask body 100. The cushion 200 does this while maintaining a thin profile and reasonable comfort for the user.

The cushion 200 may include an external membrane bladder containing a fluid, for example a gel, for example a silicone gel. The external membrane bladder may be formed from one or more thermopolymer sheets. Thermopolymer sheet material is known to one of ordinary skill in the art. Examples of thermopolymer sheet materials include those comprising urethane, polyurethane, latex, nitrile, and other natural and synthetic polymers. The external membrane bladder may be formed from a sheet of thermopolymer comprising, for example, first and second thermopolymer sheet portions. The term “thermopolymer sheet portion” is defined to mean a portion of a single sheet folded or otherwise manipulated to form more than one face of the external membrane bladder.

In some embodiments, gel (e.g., silicone gel) may be used to fill the external membrane bladder. According to the present disclosure, a cushion 200, having an external membrane bladder filled with gel, may have a durometer value of 60 or less on a Type 000 Shore scale, a durometer value of 50 or less on a Type 000 Shore scale, a durometer value of 40 or less on a Type 000 Shore scale, a durometer value of 30 or less on a Type 000 Shore scale, a durometer value of 20 or less on a Type 000 Shore scale, or a durometer value of 10 or less on a Type 000 Shore scale. However, it is noted that the present disclosure envisions materials, other than gel, being used to fill the external membrane bladder while still maintaining a durometer value of 60 or less on a Type 000 Shore scale.

The perimeter contact section, above the mentolabial crease, of the cushion 200 (apart from the convex portion 202) may be configured with at least three primary faces: a skin contact face; an attachment face; and a third face. In some embodiments, at least a portion of the cushion 200 may be trapezoidal in cross-section (e.g., at areas to be place at either side of the user's nose). The surface contact area is generally flat.

The cushion 200 may establish a perimeter seal, above the mentolabial crease, using the skin contact face of the cushion 200. Headgear (e.g., with at least two points of contact on the mask body 100) may distribute pressure on the flexible mask body 100, thereby causing it to form around the user's face. In embodiments where the cushion 200 includes an external membrane bladder, the external membrane bladder may stretch slightly for the primary fit on the user's face, and the fluid (in the cushion 200) may fill and relieve higher points, as well as fill in small gaps through compression in a local area, redistributing fluid nearby similar to a water balloon. This results in uniform pressure on the segments of the airtight seal between the cushion 200 and the user's face.

Certain points of redistribution cause reinforcement barriers, particularly as the seal changes primary direction or plane. Using one continuous external membrane bladder for the cushion 200 may have significant benefit during the transition of the direction or plane. As the redistribution locally happens around a corner in the cushion 200, the redistribution pushes the fluid towards the apex, thereby creating reinforcement.

Changing planes requires a transition from a perimeter seal to a surface seal. By using a thicker perimeter seal and a thinner surface seal, the redistribution can provide even stronger reinforcement. Using a thin surface section below the mentolabial crease allows for the external membrane bladder to maximize its ability to stretch while the fluid keeps adequate pressure to maintain seal.

The ability to stretch while maintaining pressure on surfaces, and reinforce around corners, is essential as users must be able to talk without breaking seal. This is clearly demonstrated in all fit tests as they require people to recite a portion of the Rainbow Passage, a public domain text that is phonetically balanced. The Rainbow Passage was chosen for fit testing as it demonstrates a mask wearer can produce the variety of sounds and mouth movements used in normal, unscripted English speech without compromising seal.

### Filter Support Structure

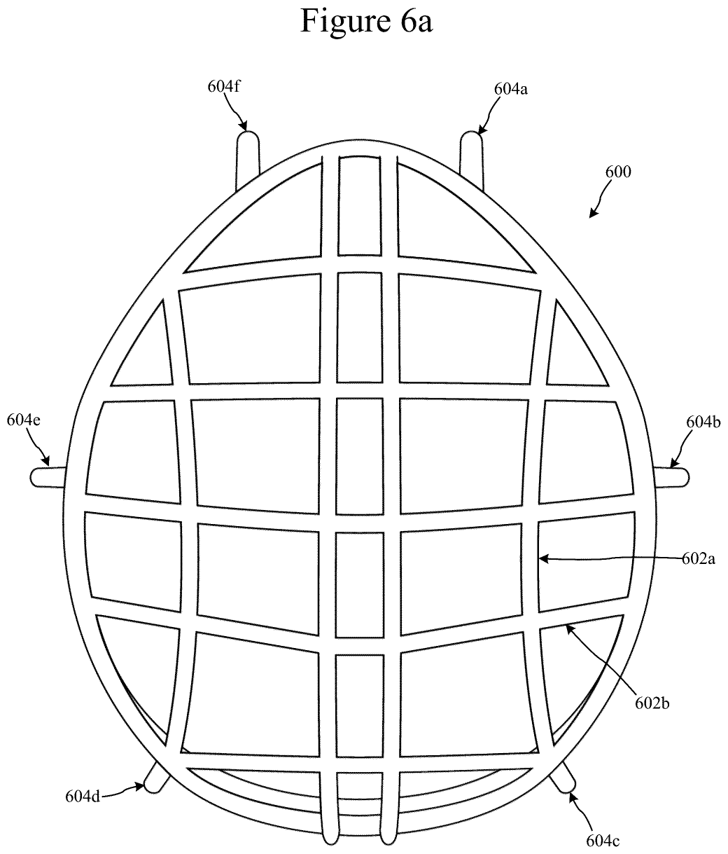

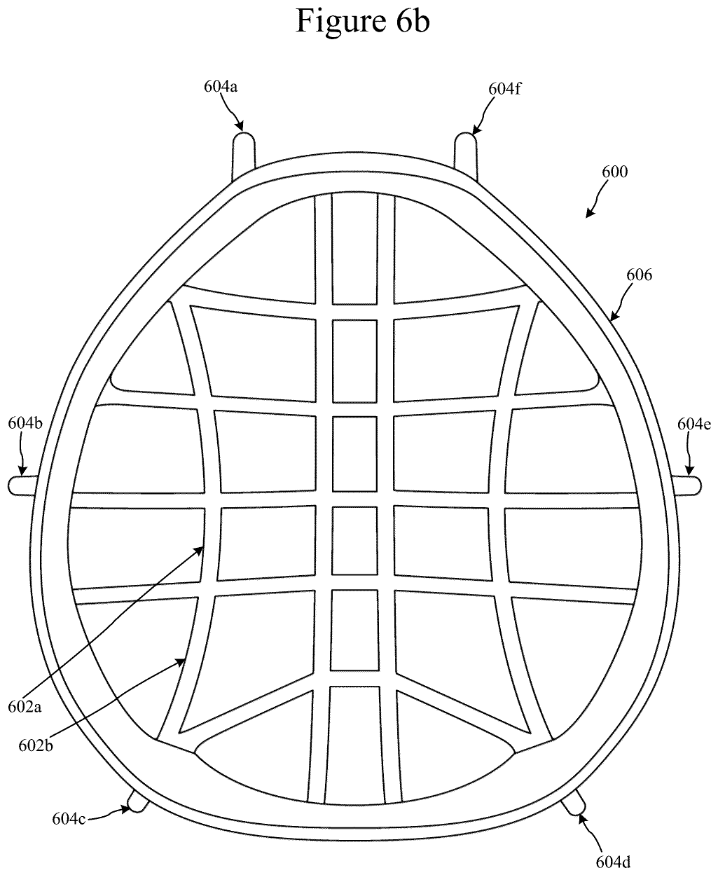

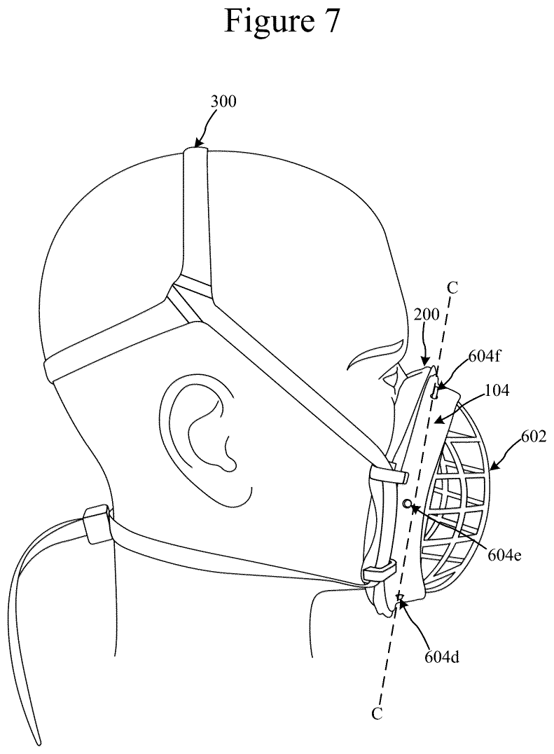

FIGS. 6a and 6b illustrate an example filter support structure 600 of the present disclosure. FIG. 7 shows the filter support structure 600 coupled to the mask body 100.

The filter support structure 600 may be a resilient, flexible structure. By resilient, it is meant that the filter support structure 600 is configured to recoil or spring back into a “resting” configuration after being bent, stretched, and/or compressed. In any event, the filter support structure 600 may be composed of a material sufficiently rigid to maintain tautness of a filter, and to couple and engage a filter to and with the flexible rim 104 (of the mask body 100) to create an airtight seal between the filter and the flexible rim 104. The filter support structure 600 may be outwardly biased and configured to engage a complementary inwardly-biased flexible rim 104 of the mask body 100.

In some embodiments, the filter support structure 600 may be made using one or more Low Density Polyethylenes (LPDEs), one or more polypropylenes, and/or one or more Thermoplastic Polyurethanes (TPUs).

The filter support structure 600 may include support elements 602 forming a convex surface configured for placement against and to support an inner concave surface of a filter. In some embodiments, the convex surface (formed by the support elements 602) may substantially or entirely correspond to the inner concave surface of the filter. The skilled person will recognize that the configuration of the support elements 602 is configurable. In some embodiments, the support elements 602 may be oriented in a substantially horizontal configuration. In some embodiments, the support elements 602 may be oriented in a substantially vertical configuration. In some embodiments (as illustrated in FIGS. 6a through 7) the support elements 602 may be configured as a lattice.

The filter support structure 600 includes extension elements 604 configured to extend through corresponding apertures, in a filter, to engage the filter against the filter support structure 600. In some embodiments, the extension elements 604 extends outwardly through the apertures of the filter. In some embodiments, the filter support structure 600 includes a continuous back perimeter 606, and the extension elements 604 extend outwardly from the continuous back perimeter 606. In some embodiments, the continuous back perimeter 606 may form a plane C-C of the filter support structure 600, and the extension elements 604 may extend outwardly along the plane C-C.

In addition to being configured to extend (outwardly) through apertures in a filter, the extension elements 604 are configured to extend (outwardly) through corresponding apertures 108 in the flexible rim 104. For example, the extension elements 604 may be configured to extend through the corresponding apertures 108 after the extension elements 604 have been extended through corresponding apertures in the filter. Thus, the extension elements 604 may be used to first couple the filter support structure 600 to a filter, and secondly couple the filter support structure 600 to the mask body 100. The foregoing results in the filter support structure 600 contacting the filter with the flexible rim 104 to create an airtight seal between the filter and the flexible rim 104

Notwithstanding the foregoing description, the skilled person will recognize that the six extension element embodiment of FIGS. 6a through 7 is illustrative, and that other numbers and positions of the extension elements 604 are possible and within the scope of the present disclosure.

### Filters

The facemasks of the present disclosure may utilize various kinds of filters.

In some embodiments, the filter may be configured to filter particles and/or organic vapors. In some embodiments, the filter may be N95, P95, KN95, FFP2, FFP3, P99, P100, R95, R99, and/or R100 grade.

In some embodiments, the filter may be a non-woven material.

In some embodiments, the filter may be disposable, meaning a filter may be used, and then removed and disposed of (and optionally replaced with a subsequent permanent or disposable filter).

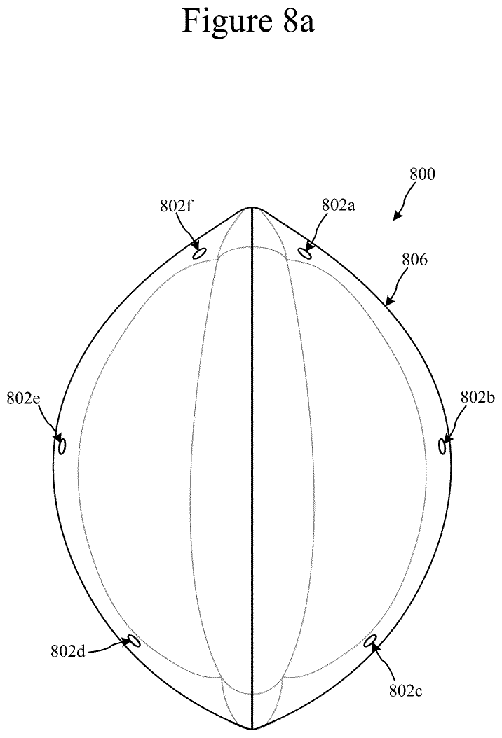

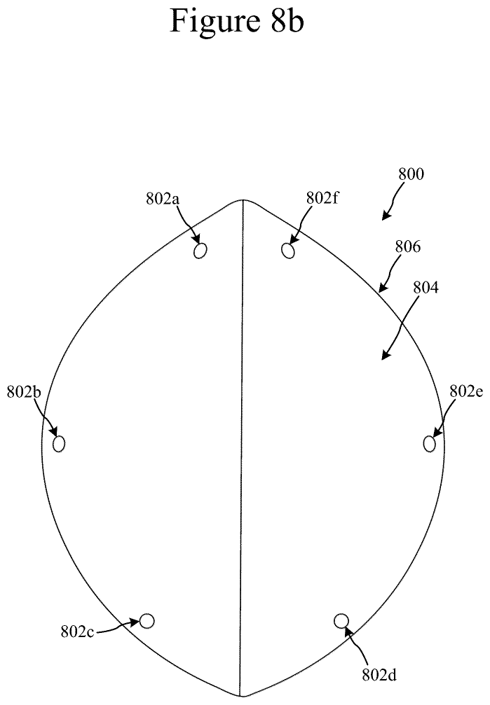

An example of a filter 800 of the present disclosure is illustrated in FIGS. 8a and 8b. As illustrated, the filter 800 may include apertures 802 through which the extension elements 604 (of the filter support structure 600) may extend for purposes of coupling the filter 800 to the filter support structure 600 (e.g., for engaging and maintaining tautness of an inner concave surface 804, of the filter 800, against the support elements 602 of the filter support structure 600) and creating an airtight seal between the filter 800 to the flexible rim 104 of the mask body 100.

As illustrated, each of the apertures 802 may be located proximate to a continuous perimeter edge 806 of the filter 800. However, the skilled person will recognize that the aperture embodiment of FIGS. 8a and 8b is illustrative, and that other numbers and positions of the apertures 802 are possible and within the scope of the present disclosure.

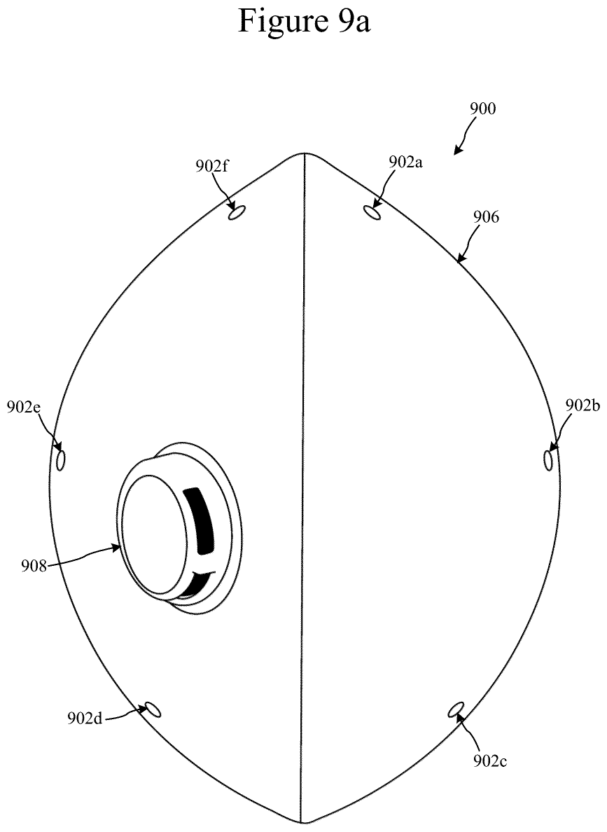

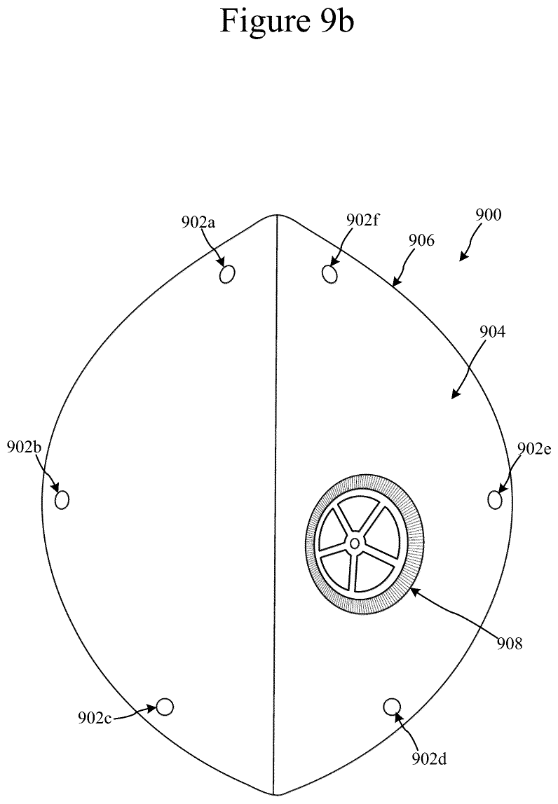

Another example of a filter 900 of the present disclosure is illustrated in FIGS. 9a and 9b. As illustrated, the filter 900 may include apertures 902 through which the extension elements 604 (of the filter support structure 600) may extend for purposes of coupling the filter 900 to the filter support structure 600 (e.g., for engaging and maintaining tautness of an inner concave surface 904, of the filter 900, against the support elements 602 of the filter support structure 600) and creating an airtight seal between the filter 900 to the flexible rim 104 of the mask body 100.

As illustrated, each of the apertures 902 may be located proximate to a continuous perimeter edge 906 of the filter 900. However, the skilled person will recognize that the aperture embodiment of FIGS. 9a and 9b is illustrative, and that other numbers and positions of the apertures 902 are possible and within the scope of the present disclosure.

As compared to the filter 800, the filter 900 may include a respirator valve 908. As known to the skilled person, the respirator valve 908 may block out inhalation of airborne contaminants, while also permitting the exhale of airborne contaminants, thereby cooling the user.

### Facemasks without Extension Elements

The foregoing disclosure describes the mask body 100 as including the flexible rim 104 having the apertures 108, the filter support structure 600 having the extension elements 604, and the filter 700/800 having the apertures 802/902.

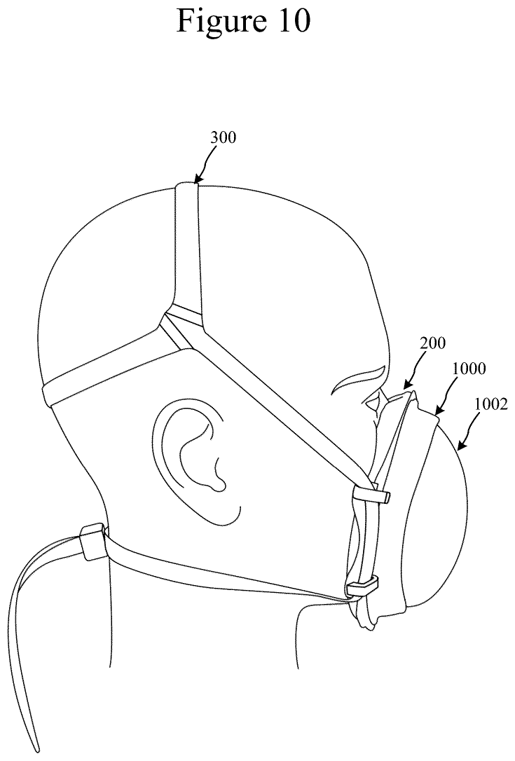

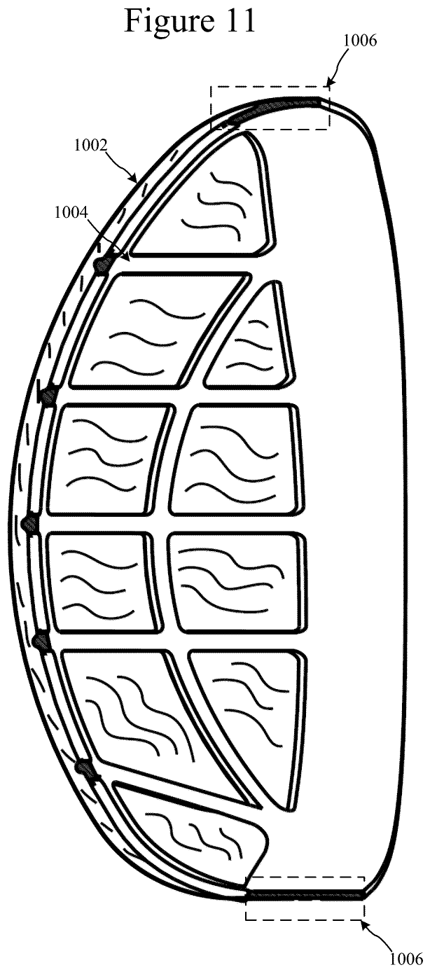

Referring to FIGS. 10 and 11, the present disclosure also relates to facemasks including a mask body 1000, a filter support structure 1004, and a filter 1002. The mask body 1000 corresponds to the mask body 100, except the flexible rim 104 (of the mask body 1000) is configured without the apertures 108. The filter support structure 1004 corresponds to the filter support structure 600 except being configured without the extension elements 604. The filter 1002 corresponds to the filter 700/800 except being configured without the apertures 702/802.

The filter 1002 may be permanently coupled to the filter support structure 1004. For example, the filter 1002 may be coupled to the filter support structure 1004 using at least one of adhesion (e.g., glue), welding, and crimping. In some embodiments, an inner portion, proximate to a perimeter edge of the filter 1002, may be adhesively coupled to an outer surface of the filter support structure 1004 (illustrated by the dashed boxes 1006 in FIG. 11).

The filter 1002 may alternatively being removably coupled to the filter support structure 1004. For example, in some embodiments the filter support structure 1004 may include a continuous channel (e.g., positioned proximate to and along a perimeter edge of the filter support structure 1004, i.e., the rightmost edge in FIG. 11), and the filter 1002 may be coupled to the filter support structure 1004 by securing a portion of the filter 1002 in the continuous channel using an o-ring (also known as a packing or a toric joint, a mechanical gasket in the shape of a torus; a loop of elastomer with a round cross-section).

In the example of FIGS. 10 and 11, the filter 1002 may establish an airtight seal with the flexible rim (of the mask body 1000) due to a direct friction fitting of the filter 1002 (and optionally the filter support structure 1004) to the flexible rim. For example, the flexible rim may be inwardly angled and biased, and an external edge portion of the filter 1002 (and optionally an external edge portion of the filter support structure 1004) may be outwardly biased and directly friction fit against an inner surface of the flexible rim.

### Facemasks with Filter Cartridges

Half mask respirators are routinely designed for harsh environments. Some respirators have components that last for multiple uses. Chambers worn on the face, valves, and headgear may last for up to a year. Some media is single use, but other types may be used up to a saturation point or maximum time from first use.

Removable filtration media must be correctly secured in the respirator housing, as incorrect placement may cause leaks. Media may be designed to work in conjunction with certain mask designs to ensure the wearer is using the proper filtration for that design. Manufacturers sometimes incorporate proprietary connections, use unique sizes for exact fit, and have components snap into place to provide feedback confirming proper installation.

It is beneficial for installation and removal to be simple, and it is important that it be impossible to install the wrong component. Sometimes media needs to be installed on location, requiring the wearer to leave the environment, but the wearer may still have contaminated hands making it important that installation can be done without contaminating the new media.

Airflow direction is important in almost all applications. Offsets are sometimes employed to make the filtration media fit only one way. Filtration media is often marked to show the side intended to face the harsh environment for this purpose.

Filter cartridges offer several if not all the foregoing benefits as the cartridge can be handled by the wearer with dirty hands, only installs one way, and provides positive feedback of proper fit.

A single-use flat filter housed inside a chamber may be used in less harsh environments requiring a lower level of protection, such as N95.

Layers of protection and valves to direct air can protect filters and cartridges from both physical damage and contamination from exhaled breath.

A wall between the cartridge with an opening for a one-way valve allows for inhaled air and prohibits exhaled air from passing through the filter.

One or more one-way valves can be used to exhale air in a harsh environment.

One-way valves may incorporate filters externally to avoid particulates from exhaled air to pass through into the surrounding environment.

The present disclosure provides facemasks having a perimeter seal design and an assembly to accept a filter cartridge, filter, or both. When a filter is used without a cartridge, the filter may be protected by a filter cover. When a filter is used in addition to a cartridge it may be covered by the cartridge and intended for use in applications where the cartridge is used for filtering contaminants the filter is not capable of filtering by itself. An example of this is an organic vapor cartridge with a particulate filter behind it.

The use of a cartridge may offer assurance of a secure seal via tactile feedback. A cartridge often has media that is exposed to the harsh environment with an exit into the mask. As the air moves past the cartridge, it may enter the breathing chamber through a one-way valve, thereby avoiding a backwash or exhaled air, saliva, and other elements to contaminate the cartridge.

One or more exhalation ports may serve as one or more one-way paths for exhaled air to leave the breathing chamber. The exhalation port(s) may or may not have filtration for exhaled air. In some embodiments, the intention of the exhalation port(s) is to have a path for warm, moist, CO₂ rich air to leave the breathing chamber with less resistance than the path inward, and to provide a path that does not contaminate the cartridge. A low resistance purge of chamber gasses may be beneficial for comfort and cooling.

In some social and medical environments there is a concern of contamination in both directions. The filter's orientation may favor the wearer, as the filter may only filter about 85% in a secondary direction.

For some (e.g., medical) applications the filter may be oriented towards protecting the wearer's surrounding environment from the wearer's contaminants. This may require a filter specifically designed for this, or the use of a symmetrical, flat design that can be reversed.

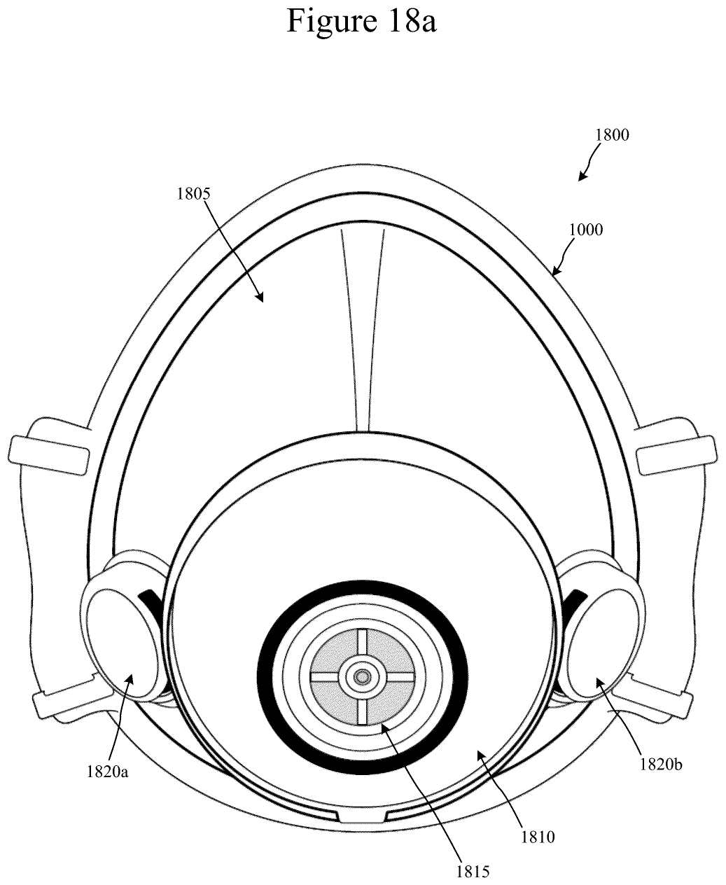

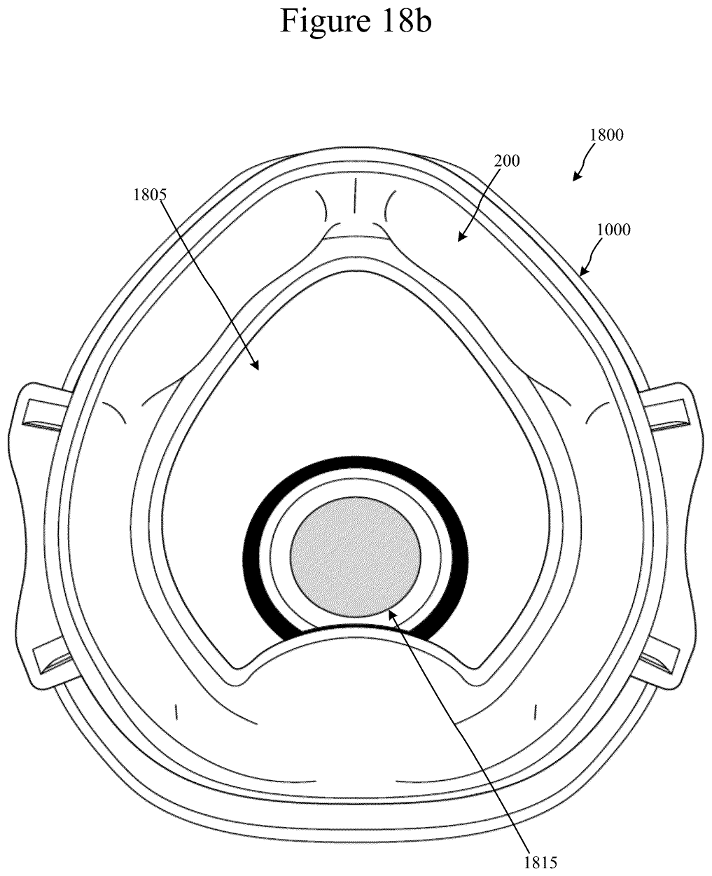

FIGS. 18a and 18b illustrate components of a reusable, flexible facemask 1800 of the present disclosure. The facemask 1800 includes the mask body 1000 having the cushion attachment surface 102 removably or permanently coupled to the cushion 200. The facemask 1800 further includes a housing 1805 including an outer convex surface and a corresponding inner concave surface defining a breathing chamber of the facemask 1800.

For example and not limitation, the housing 1805 may be made using one or more of polyvinyl chloride (PVC), polypropylene, nylon, silicon, or other like material(s).

The housing 1805 may establish an airtight seal with the flexible rim of the mask body 1000 due to a direct friction fitting of the housing 1805 to the flexible rim. For example, the flexible rim may be inwardly angled and biased, and an external edge portion of the housing 1805 may be outwardly biased and directly friction fit against an inner surface of the flexible rim.

The housing 1805 includes a filtration media coupler 1810 configured to removably receive and couple to a cartridge, filter, or both. The filtration media coupler 1810 may be configured to form an airtight seal with the cartridge, filter, or both.

The housing 1805 also includes a port 1815 configured to permit the ingress, and optionally egress, of air into, and optionally from, the breathing chamber of the facemask 1800 by a wearer thereof. In some embodiments, the port 1815 include an aperture positioned in the housing 1805 that permits the ingress and egress of air into and from the breathing chamber. In other embodiments, the port 1815 may be an inhalation port configured to only allow air to ingress into the breathing chamber. In such embodiments, the port 1815 may include a one-way valve configured to only permit air to ingress into the breathing chamber. The present disclosure envisions the foregoing one-way valve to be any presently known or yet to be discovered one-way valve.

The housing 1805 may optionally include one or more exhalation ports 1820. While FIGS. 18a and 18b illustrate an embodiment of the housing 1805 including a first exhalation port 1820a and a second exhalation port 1820b, the present disclosure is not limited thereto. That is, the housing 1805 may be configured without any exhalation ports, may be configured with a single exhalation port, two exhalation ports, three exhalation ports, etc. The exhalation port(s) 1820 may include a one-way valve configured to only allow air to egress from the breathing chamber. The present disclosure envisions the foregoing one-way valve(s) to be any presently known or yet to be discovered one-way valve(s).

In some embodiments, an exhalation port 1820 may include a filter positioned between the one-way value of the exhalation port and the breathing chamber of the facemask. The filter may be configured to filter particles and/or organic vapors. The filter may be N95, P95, KN95, FFP2, FFP3, P99, P100, R95, R99, and/or R100 grade. In some embodiments, the filter may be a non-woven material. In some embodiments, the filter may be disposable, meaning it may be used, and then removed and disposed of (and optionally replaced with a subsequent permanent or disposable filter).

In embodiments where the housing 1805 is configured without any exhalation ports, the port 1815 may be configured without a one-way valve. That is the port 1815 may include the aperture that permits the ingress and egress of air into and from the breathing chamber.

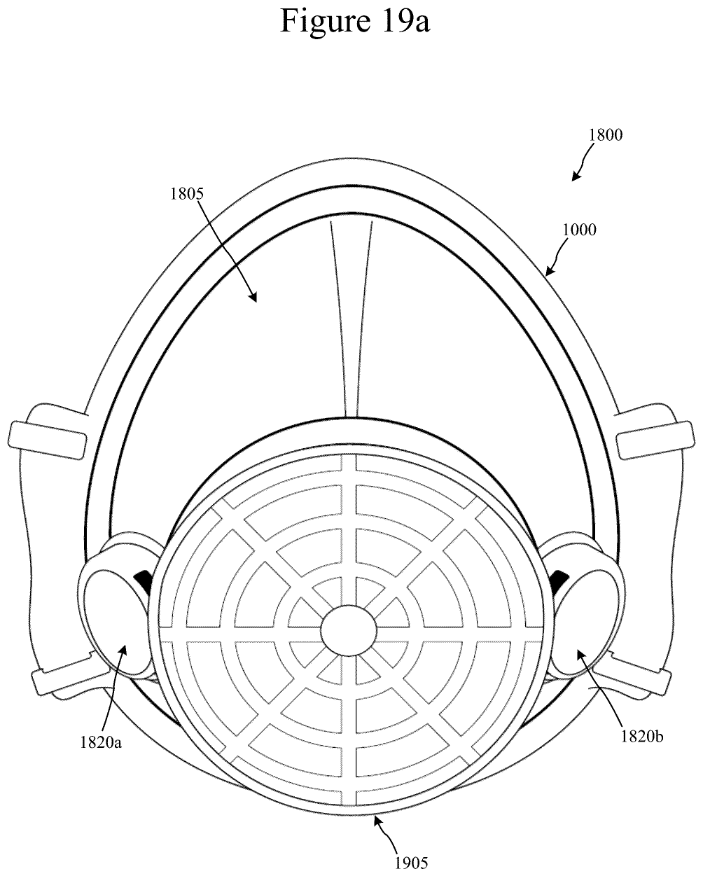

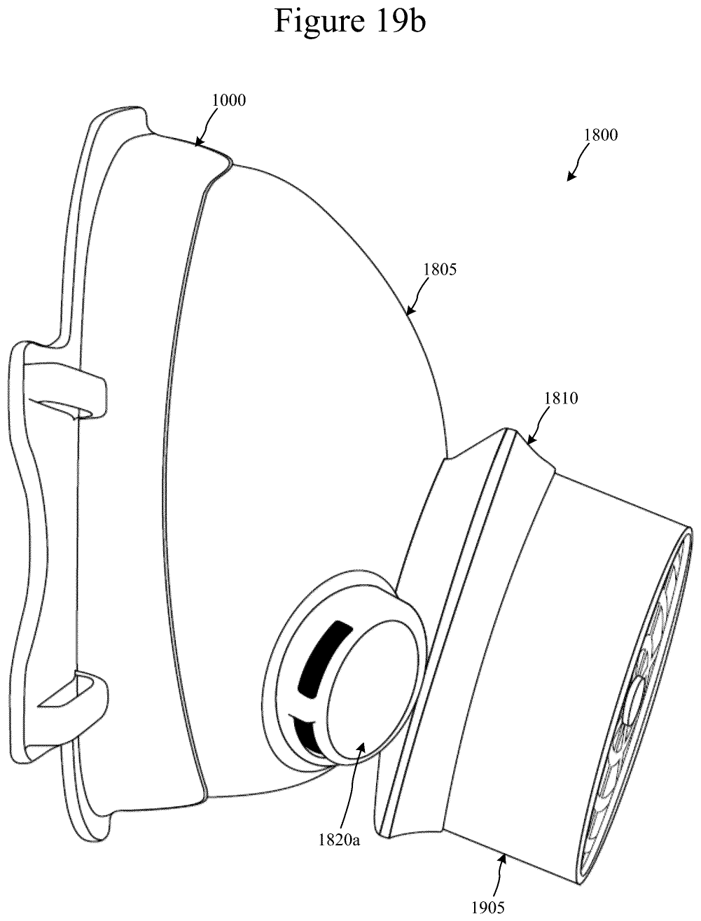

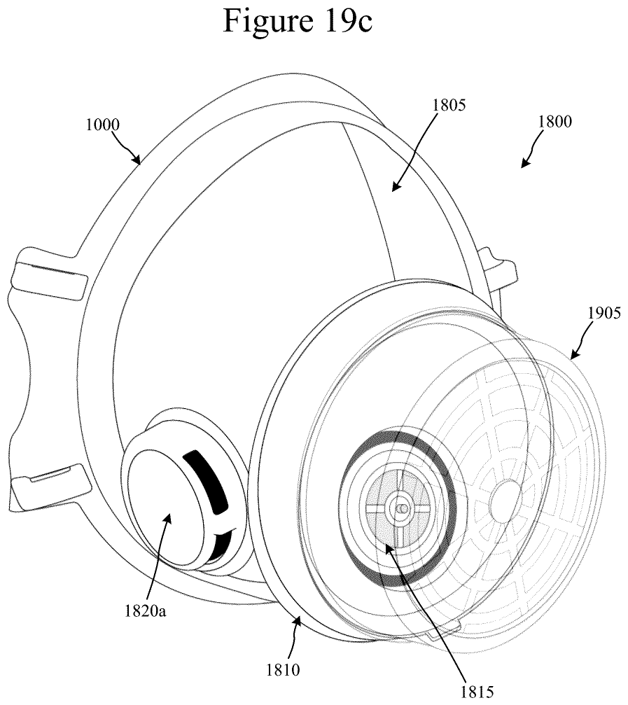

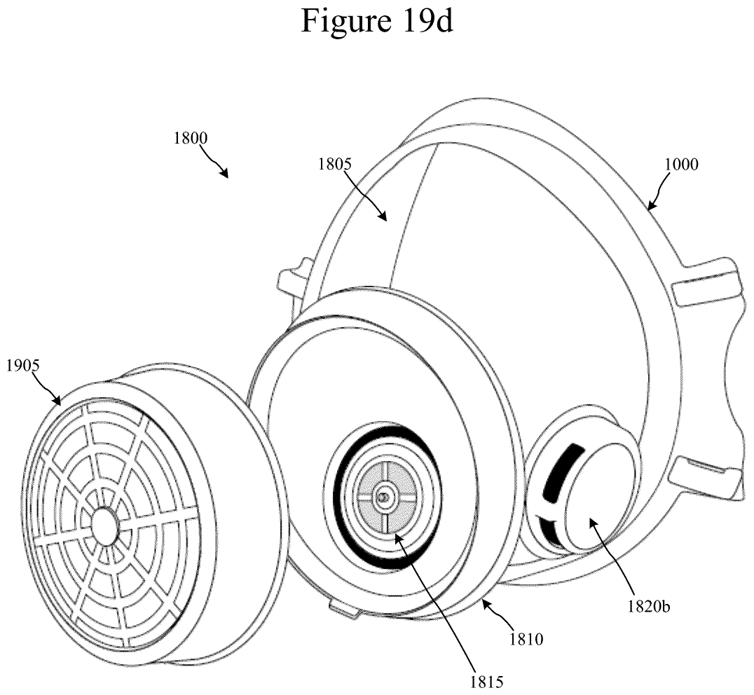

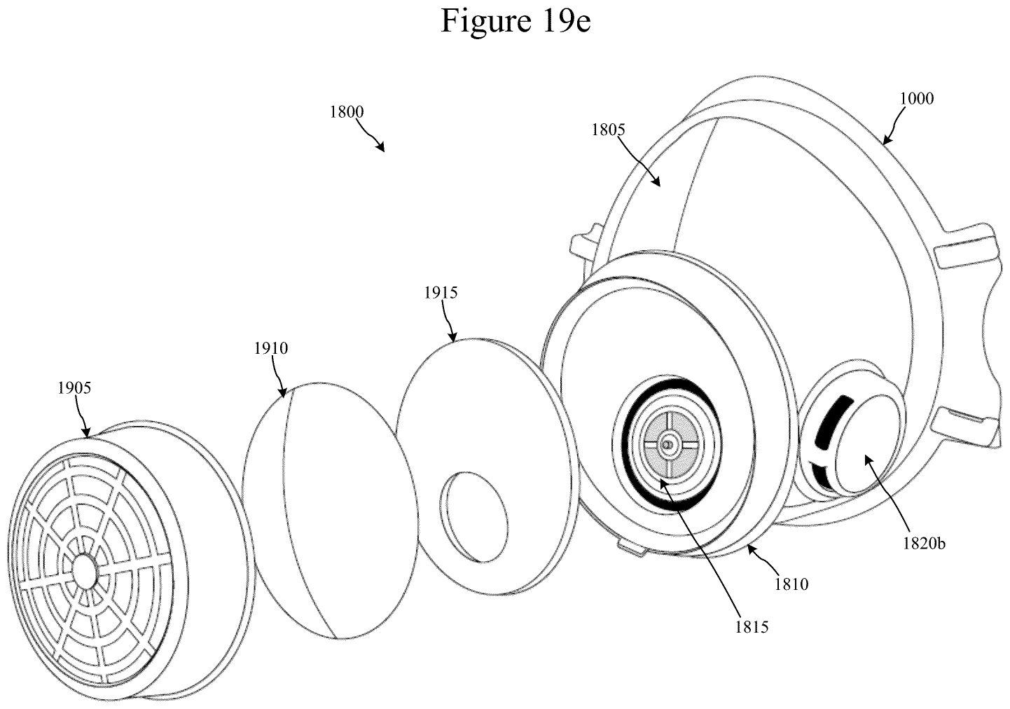

Referring to FIGS. 19a through 19e, some embodiments of the facemask 1800 may include a filter cartridge 1905, and optionally a filter 1910, and optionally a filter holder 1915. As used herein, a “filter cartridge” refers to a standalone, non-serviceable, entirely disposable structure having a three-dimensional filtration divide (e.g., cylinder, rectangular box, etc.) that is framed and includes a filtration media inside. The filtration media in the filter cartridge 1905 may be capable of removing gases, volatile organic compounds, vapors, and/or other materials from air through adsorption, absorption, or chemisorption.

The filter cartridge 1905 removably couples to the filtration media coupler 1810 of the housing 1805. The filter cartridge 1905 may removably couple to the filtration media coupler 1810 using any already known or yet discovered coupling means. By way of illustration and not limitation, the filter cartridge 1905 may removably couple to the filtration media coupler 1810 using a threaded mechanism, a snap mechanism, and/or friction fitting. All that is required is that coupling of the filter cartridge 1905 to the filtration media coupler 1810 results in an airtight seal between the filter cartridge 1905 and the filtration media coupler 1810 such that any air that enters the breathing chamber first passes through the filter cartridge 1905.

The filter cartridge 1905 may include a filtration media capable of filtering dust, fibers, or other solid particles formed or generated from solid materials through mechanical processes such as crushing, grinding, drilling, abrading, or blasting. Examples of such solid particles include lead, silica, and asbestos.

The filter cartridge 1905 may additionally or alternatively include a filtration media capable of filtering mists, or tiny droplets of liquid suspended in air. Example mists include oil mist, acid mist, and paint spray mist.

The filter cartridge 1905 may additionally or alternatively include a filtration media capable of filtering gases, or materials that exist as individual molecules in the air at room temperature. Examples of such gases include welding gases (e.g., acetylene and nitrogen) and carbon monoxide.

The filter cartridge 1905 may additionally or alternatively include a filtration media capable of filtering vapors, or the gaseous form of substances that are commonly in the solid or liquid state at room temperature and pressure. Vapors are formed by evaporation. Example vapors include toluene and methylene chloride.

As illustrated in FIG. 19e, in some embodiments the facemask 1800 may include the filter 1910 and the filter holder 1915. However, the present disclosure is not limited thereto. In some embodiments, the facemask 1800 may include the filter 1910 without including the filter holder 1915. The filter 1910, and optionally the filter holder 1915, may be positioned within the filtration media coupler 1810 between the filter cartridge 1905 and the port 1815. In embodiments where the facemask 1800 includes the filter holder 1915, the filter holder 1915 may be positioned between the filter 1910 and the port 1815.

In some embodiments, the filter 1910 may be configured to filter particles and/or organic vapors. In some embodiments, the filter 1910 may be N95, P95, KN95, FFP2, FFP3, P99, P100, R95, R99, and/or R100 grade.

In some embodiments, the filter 1910 may be a non-woven material.

In some embodiments, the filter 1910 may be disposable, meaning it may be used, and then removed and disposed of (and optionally replaced with a subsequent permanent or disposable filter).

The filter 1910 may establish an airtight seal (or nearly airtight seal) with the filtration media coupler 1810 due to a direct friction fitting of an outer perimeter of the filter 1910 to the filtration media coupler 1810.

The filter holder 1915 may be utilized to provide support to the filter 1910. The filter holder 1915 may be utilized when the filter 1910 is not separately contained within a sturdy frame. For example, the filter holder 1915 may be utilized when a thickness of the filter 1910 is less than a thickness of the filtration media coupler 1810. The filter holder 1915 may be any structure and material capable of being positioned between the filter 1910 and the port 1815, and configured to maintain the filter 1910 in a relatively constant (or constant) position with respect to the filter cartridge 1905 during movement of the facemask 1800 and inhalation and exhalation of the user. In some embodiments, the filter holder 1915 may include an aperture having an outer perimeter corresponding (or substantially corresponding) to an outer perimeter of the port 1815. In operation, the outer perimeter of the aperture of the filter holder 1915 may correspond to the outer perimeter of the port 1815. In operation, the outer perimeter of the aperture of the filter holder 1915 may be axially aligned with the outer perimeter of the port 1815.

### Facemasks without Filter Cartridges

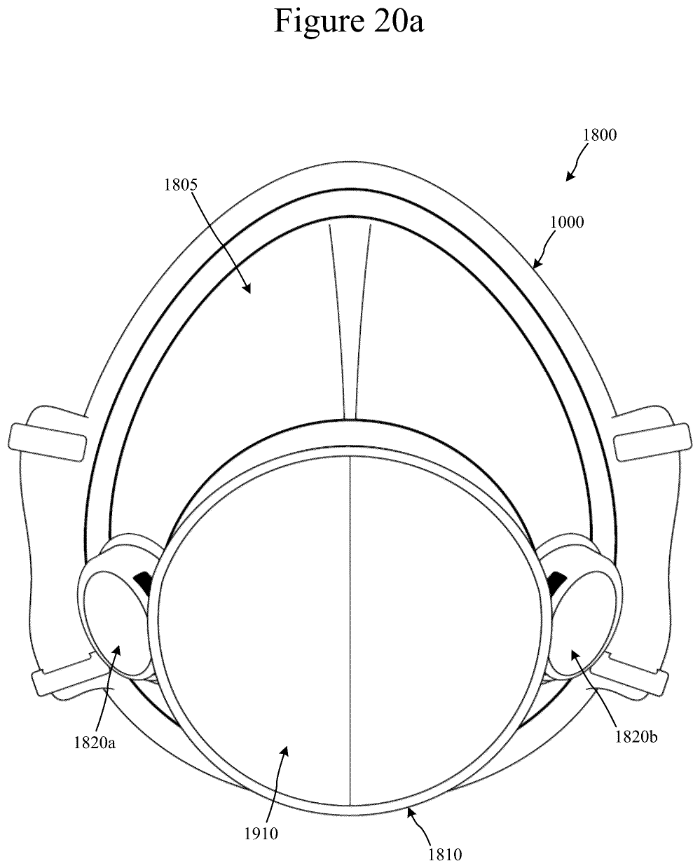

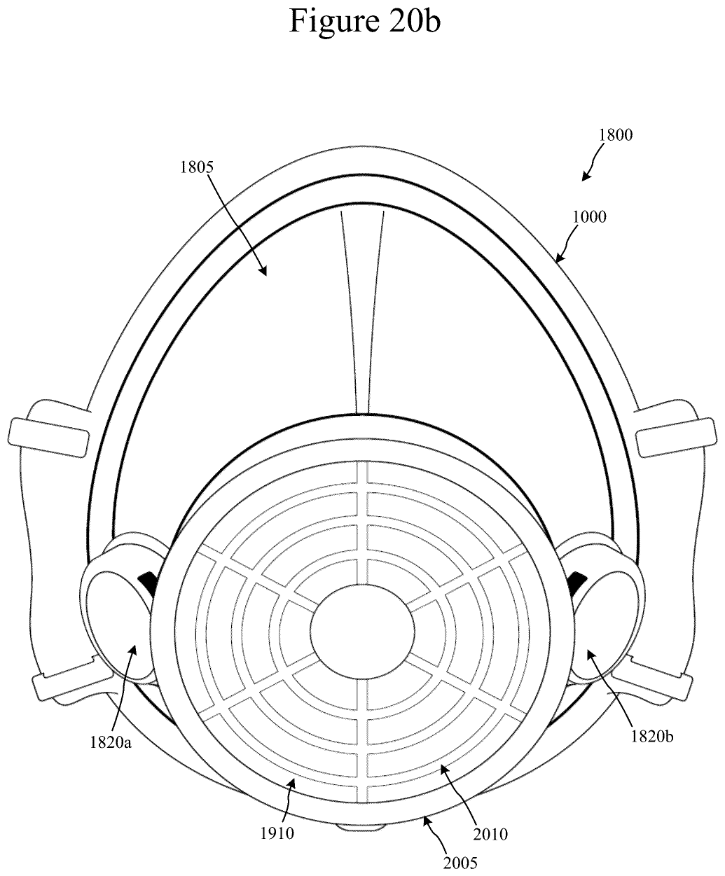

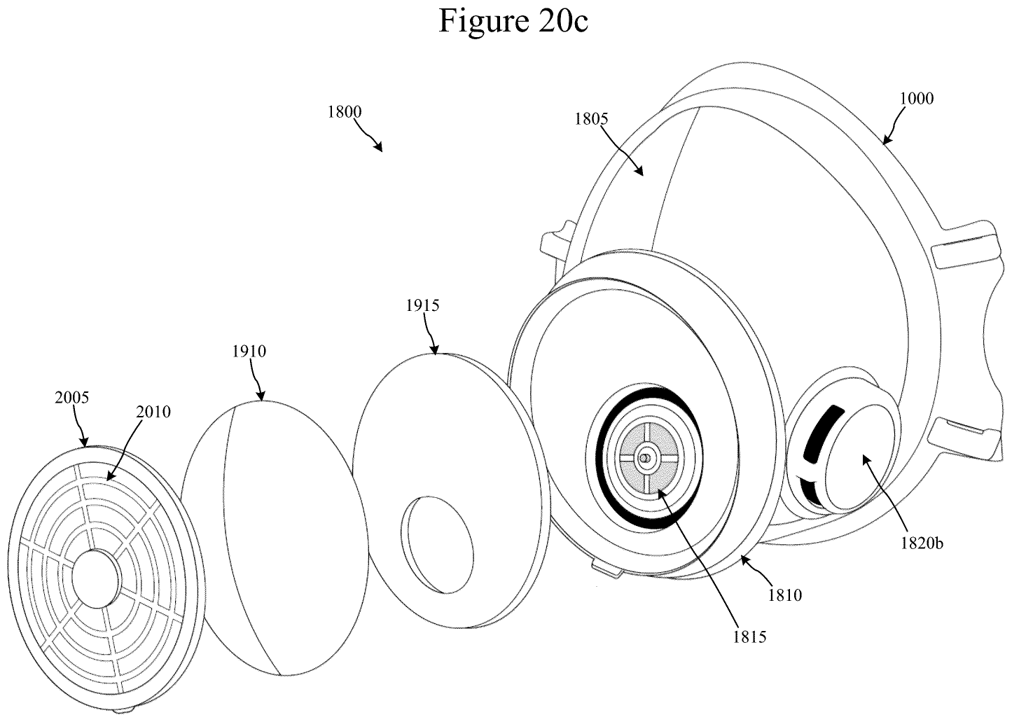

Referring to FIGS. 20a through 20c, some embodiments of the facemask 1800 may include the filter 1910, and optionally the filter holder 1915, and a filter retaining element 2005, without including the filter cartridge 1905.

The filter 1910, and optionally the filter holder 1915, may be removably positioned within the filtration media coupler 1810 of the housing 1805, and removably retained in place by a filter retaining element 2005. In embodiments where the facemask 1800 includes the filter holder 1915, the filter holder 1915 may be positioned between the filter 1910 and the port 1815.

The filter retaining element 2005 removably couples to the filtration media coupler 1810 of the housing 1805. The filter retaining element 2005 may removably couple to the filtration media coupler 1810 using any already known or yet discovered coupling means. By way of illustration and not limitation, the filter retaining element 2005 may removably couple to the filtration media coupler 1810 using a threaded mechanism, a snap mechanism, and/or friction fitting. All that is required is that coupling of the filter retaining element 2005 to the filtration media coupler 1810 results in an airtight seal between the filter 1910, the filter retaining element 2005, and the filtration media coupler 1810 such that any air that enters the breathing chamber first passes through the filter 1910.

The filter retaining element 2005 may include a flat (or relatively flat) portion 2010 including one or more apertures therein. When the filter retaining element 2005 is removably coupled to the filtration media coupler 1810, the flat (or relatively flat) portion 2010 abuts or closely approaches the filter 1910. This configuration of the flat (or relatively flat) portion 2010 may assist in ensuring an airtight seal exists between the filter 1910, the filter retaining element 2005, and the filtration media coupler 1810 such that any air that enters the breathing chamber first passes through the filter 1910. In other words, the flat (or relatively flat) portion 2010 may assist in causing the filter 1910 to cover the entire (or nearly entire) cross-section of the filtration media coupler 1810.

For example and not limitation, the filter retaining element 2005 may be made using one or more of polyvinyl chloride (PVC), polypropylene, nylon, or other like material(s).

The filter holder 1915 may be utilized when the filter 1910 is not separately contained within a sturdy frame. For example, the filter holder 1915 may be utilized when a thickness of the filter 1910 is less than a thickness of the filtration media coupler 1810. The filter holder 1915 may be any structure and material capable of being positioned between the filter 1910 and the port 1815, and configured to maintain the filter 1910 in a relatively constant (or constant) position with respect to the filter retaining element 2005 during movement of the facemask 1800 and inhalation and exhalation of the user.

### Facemask Kits

Various facemask kits are envisioned within the scope of the present disclosure.

A first kit may include the mask body 100, the filter 800/900, and the filter support structure 600, where the mask body 100, the filter 800/900, and the filter support structure 600 are fully disassembled.

The mask body 100 of the first kit may include the cushion attachment surface 102 and the flexible rim 104. The flexible rim 104 may extend inwardly away from the cushion attachment surface 102. Moreover, the flexible rim 104 may include the apertures 108.

Within the first kit, the mask body 100 may have the cushion 200 coupled to the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

Within the first kit, the filter support structure 600 has the extension elements 604 configured to removably couple the filter support structure 600 to the filter 800/900 and the flexible rim 104 by: extending through the apertures 802/902 of the filter 800/900, thereby removably coupling the filter to the filter support structure 600; and after extending through the apertures 802/902, extending through the apertures 108 of the flexible rim 104, thereby engaging the filter 800/900 with the flexible rim 104 to create an airtight seal between the filter 800/900 and the flexible rim 104.

The individual components of the first kit may take on the various configurations of each component as described elsewhere herein.

A second kit of the present disclosure may include the mask body 100 and a filter assembly, where the mask body 100 is disassembled from the filter assembly.

The mask body 100 of the second kit may include the cushion attachment surface 102 and the flexible rim 104. The flexible rim 104 may extend inwardly away from the cushion attachment surface 102. Moreover, the flexible rim 104 may include the apertures 108.

Within the second kit, the mask body 100 may have the cushion 200 coupled to the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

Within the second kit, the filter assembly may include the filter 800/900 removably coupled to the filter support structure 600 by way of the extension elements 604 being extended through the apertures 802/902 of the filter 800/900. The filter assembly is configured to removably couple the filter 800/900 to the flexible rim 104 by extending the extension elements 604 (which are already extended through the apertures 802/902) through the apertures 108 of the flexible rim 104, thereby engaging the filter 800/900 with the flexible rim 104 to create an airtight seal between the filter 800/900 and the flexible rim 104.

The individual components of the second kit may take on the various configurations of each component as described elsewhere herein.

A third kit of the present disclosure may include the mask body 1000 and a filter assembly, where the mask body 1000 is disassembled from the filter assembly.

The mask body 1000 of the third kit may include the cushion attachment surface 102 and the flexible rim 104 configured without the apertures 108. The flexible rim 104 may extend inwardly away from the cushion attachment surface 102.

Within the third kit, the mask body 1000 may have the cushion 200 coupled to the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

Within the third kit, the filter assembly may include the filter 1002 permanently coupled to the filter support structure 1004 by way of, for example, adhesion.

The filter assembly is configured to removably couple the filter 1002 to the flexible rim 104 (configured without the apertures 108) by directly friction fitting the filter 1002 (and optionally the filter support structure 1004) against the flexible rim 104, thereby engaging the filter 1002 with the flexible rim 104 to create an airtight seal between the filter 1002 and the flexible rim 104.

The individual components of the third kit may take on the various configurations of each component as described elsewhere herein.

A fourth kit of the present disclosure may include the mask body 1000, housing 1805, and one or more filter cartridges 1905, where the mask body 1000 is coupled to or disassembled from the housing 1805, and the housing 1805 is coupled to or disassembled from the one or more filter cartridges 1905.

The fourth kit may optionally include the filter 1910. Within the fourth kit, the filter 1910 may be coupled to or disassembled from the filtration media coupler 1810 of the housing 1805.

The fourth kit may optionally include the filter holder 1915. Within the fourth kit, the filter holder 1915 may be coupled to or disassembled from the filtration media coupler 1810 of the housing 1805.

Within the fourth kit, the mask body 1000 may have the cushion 200 coupled to the cushion attachment surface 102.

The individual components of the fourth kit may take on the various configurations of each component as described elsewhere herein.

A fifth kit of the present disclosure may include the mask body 1000, housing 1805, and filter retaining element 2005, where the mask body 1000 is coupled to or disassembled from the housing 1805, and the housing 1805 is coupled to or disassembled from the filter retaining element 2005.

The fourth kit may optionally include the filter 1910. Within the fourth kit, the filter 1910 may be coupled to or disassembled from the filtration media coupler 1810 of the housing 1805.

The fourth kit may optionally include the filter holder 1915. Within the fourth kit, the filter holder 1915 may be coupled to or disassembled from the filtration media coupler 1810 of the housing 1805.

Within the fourth kit, the mask body 1000 may have the cushion 200 coupled to the cushion attachment surface 102.

The individual components of the fourth kit may take on the various configurations of each component as described elsewhere herein.

### Facemask Assembly

As the present disclosure relates, in part, to various facemask kits, the present disclosure also relates to various facemask assembly methods.

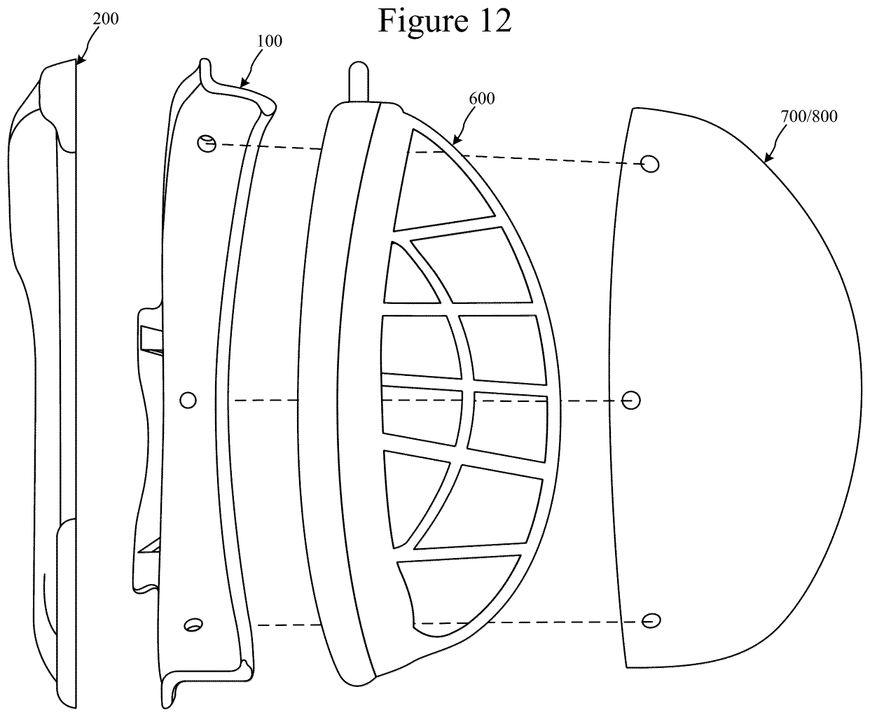

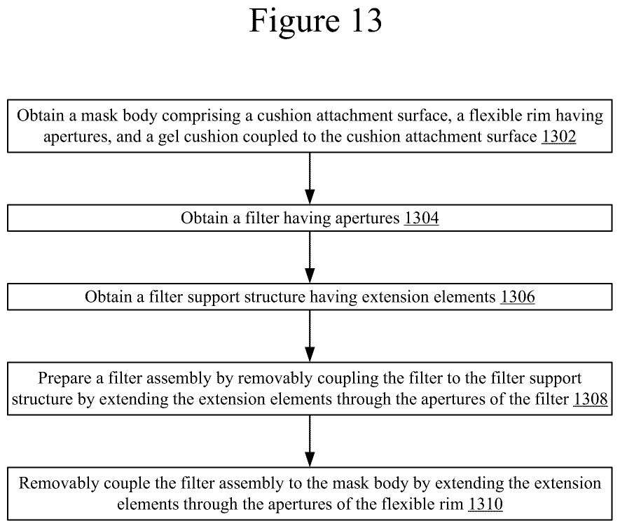

A first method of assembling a facemask, corresponding to the above-described first kit, is described below with respect to FIGS. 12 and 13.

The first method includes obtaining (step 1302) the mask body 100 comprising the cushion attachment surface 102, the flexible rim 104 having apertures 108, and the cushion 200 coupled to the cushion attachment surface 102. The flexible rim 104 may extend inwardly away from the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

The first method may include obtaining (step 1304) the filter 800/900 having apertures 802/902.

The first method may include obtaining (step 1306) the filter support structure 600 having the extension elements 604.

The first method may include preparing (step 1308) a filter assembly by removably coupling the filter 800/900 to the filter support structure 600 by extending the extension elements 604 through the apertures 802/902 of the filter 800/900.

The first method may include removably coupling (step 1310) the filter assembly to the mask body 100 by extending the extension elements 604 (already extended through the apertures 802/902 of the filter 800/900) through the apertures 108 of the flexible rim 104, thereby creating an airtight seal between the filter 800/900 and the flexible rim 104.

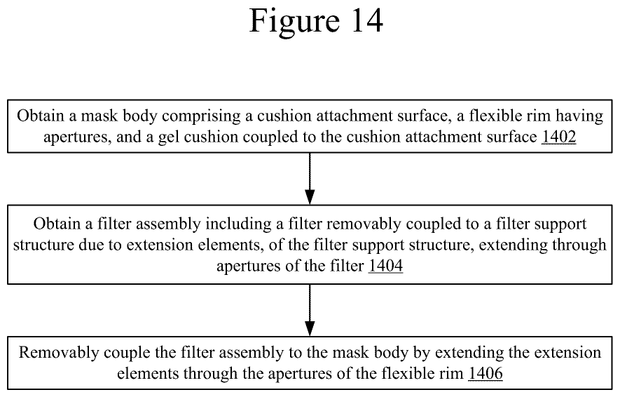

A second method of assembling a facemask, corresponding to the above-described second kit, is illustrated in FIG. 14.

The second method includes obtaining (step 1402) the mask body 100 comprising the cushion attachment surface 102, the flexible rim 104 having apertures 108, and the cushion 200 coupled to the cushion attachment surface 102. The flexible rim 104 may extend inwardly away from the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

The second method may include obtaining (step 1404) a filter assembly including the filter 800/900 removably coupled to the filter support structure 600 due to the extension elements 604, of the filter support structure 600, extending through the apertures 802/902 of the filter 800/900.

The second method may include removably coupling (step 1406) the filter assembly to the mask body 100 by extending the extension elements 604 (already extended through the apertures 802/902 of the filter 800/900) through the apertures 108 of the flexible rim 104, thereby creating an airtight seal between the filter 800/900 and the flexible rim 104.

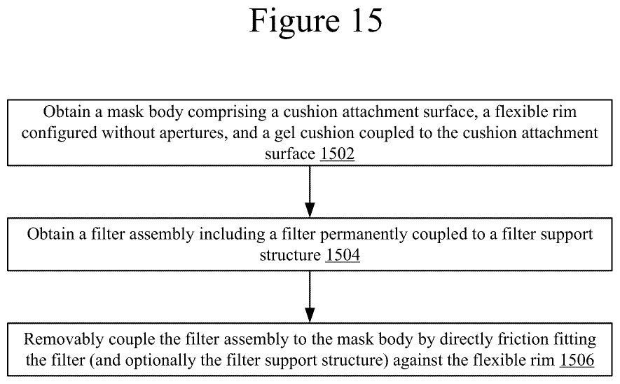

A third method of assembling a facemask, corresponding to the above-described third kit, is illustrated in FIG. 15.

The third method includes obtaining (step 1502) the mask body 1000 comprising the cushion attachment surface 102, the flexible rim 104 configured without the apertures 108, and the cushion 200 coupled to the cushion attachment surface 102. The flexible rim 104 may extend inwardly away from the cushion attachment surface 102. The cushion 200 may include the convex portion 202 that extends from the bottom portion of the cushion 200 and partway to a top portion of the cushion 200, and which is configured to contact the user's chin, below the mentolabial crease, and facilitate an airtight seal between the cushion 200 and the user's face.

The third method may include obtaining (step 1504) a filter assembly including the filter 1002 permanently coupled to the filter support structure 1004 via, for example, adhesion.

The third method may include removably coupling (step 1506) the filter assembly to the mask body 1000 by directly friction fitting the filter 1002 (and optionally the filter support structure 1004) against the flexible rim 104, thereby engaging the filter 1002 with the flexible rim 104 and creating an airtight seal between the filter 1002 and the flexible rim 104. For example, the flexible rim 104 may be inwardly angled and biased, and an external edge portion of the filter 1002 (and optionally an external edge portion of the filter support structure 1004) may be outwardly biased and directly friction fit against an inner surface of the flexible rim 104.

### EXAMPLES

### Example 1. Comparison of Seals Using Elastomeric Sealing Surface Versus Fluid-Filled Cushion

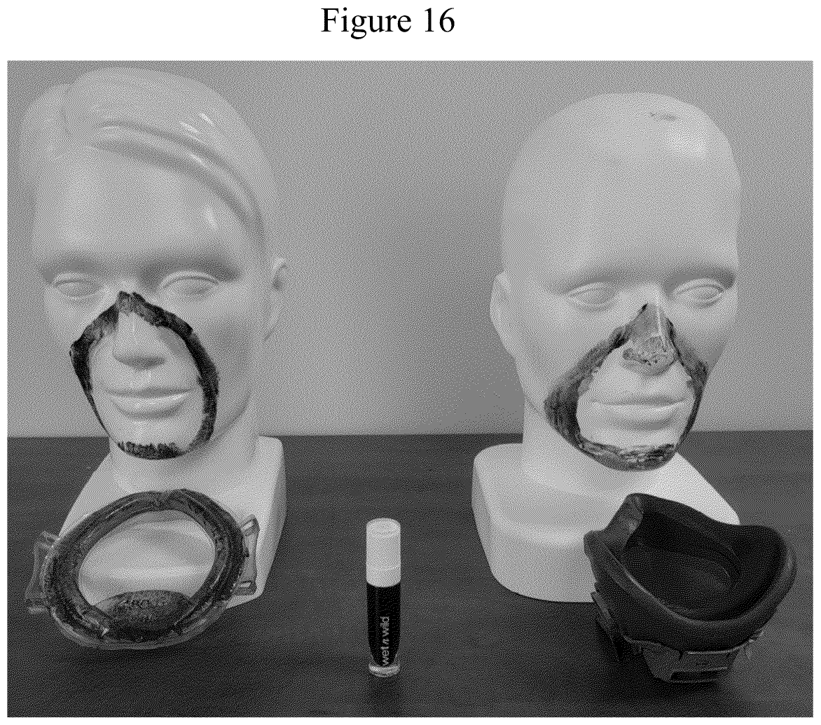

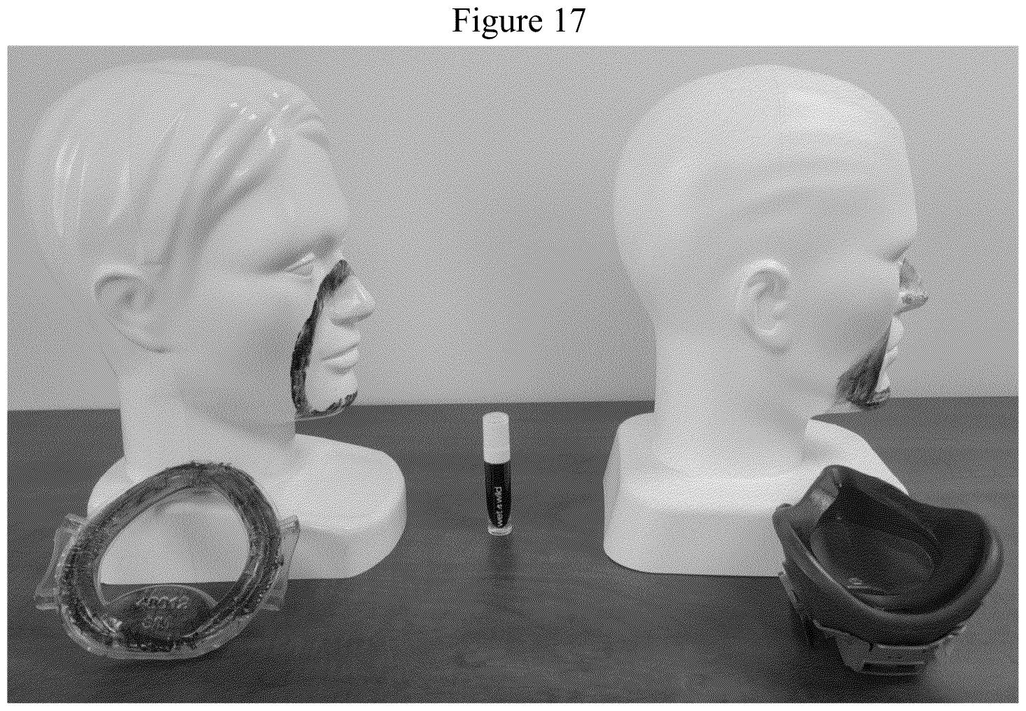

FIGS. 16 and 17 illustrate a comparison test performed using an elastomeric sealing surface and a fluid-filled cushion 200 of the present disclosure. Black lipstick was applied to the elastomeric sealing surface and the fluid-filled cushion 200. After application of the black lipstick, the elastomeric sealing surface and the fluid-filled cushion 200 were pressed against different plastic heads having the same facial geometry. Sealing, provided by the fluid-filled cushion 200, is shown by the black lipstick on the left plastic face in FIGS. 16 and 17. Sealing, provided by the elastomeric sealing surface, is shown by the black lipstick on the right plastic face in FIGS. 16 and 17.

The surface of the elastomeric mask is rubbery, elastic material that is made to make contact with the face everywhere beyond the triangular opening of the elastomeric mask. The triangular opening is made as small as possible to maximize sealing area.

As the user moves around and talks, the elastomeric mask stretches and moves to maintain seal, relying on the vast coverage area of the chin and cheeks, and particularly around the level of the mentolabial crease. Essentially, with the elastomeric mask, extra surface area and headgear tension serves as a bandage to overcome the difficulty to seal at the perimeter where it is most important.

In contrast to the elastomeric mask, with respect to the fluid-filled cushion 200, the perimeter seal, above the mentolabilal crease, seals using the outside wall. This results in a superior seal around corners as the fluid-filled cushion 200 equalized pressure to local spots. Moreover, the fluid-filled cushion 200 transitions from the perimeter seal, above the mentolabial crease, to a surface seal at the convex portion 202 (i.e., a surface seal from the mentolabial crease to below the chin). This was achieved by configuring the fluid-filled cushion 200 to have a single fluid-containing chamber that allowed the fluid to move and reinforce areas around the transition between the perimeter and surface seals, and around corners such as the bottom of the chin.

The elastomeric mask covers all over the face and under the chin with minimal open space for the nose and mouth. The elastomeric mask fits like a mold. The molded triangle is well intact when not worn and the open cavity represents the smallest size face that can fit in the area. The elastomeric mask cannot get smaller on the X and Y axis. The rubbery surface allows it to stretch on the X and Y axis, but as it reaches a limit on the Y axis the mask is pulled down the nose and the seal is broken due to the rise of the nose as it goes down the bridge. If the elastomeric mask is too large, it leaks regardless of headgear tension. When talking, the elastomeric mask has a “V” with orientation like “<”, which accommodates for some of the stretch in the Y dimension, but is mostly for movement of the chin when the user is talking. It is noteworthy that a routine fit test includes reciting the rainbow passage (i.e., a brief script used to ensure the user can carry out normal speech patterns while wearing the elastomeric mask.

In contrast, the mask body 100 and fluid-filled cushion 200 assembly of the present disclosure fits around the face, above the mentolabial crease, leaving more open area for comfort and fit range. Transition to under the chin uses a “cover the surface” approach. The fluid-filled cushion 200, at rest, represents the largest face that can be fit, and is reduced in the X axis by headgear tension and reduced in the Y axis by the tensioning effect of the convex portion 202. The fluid-filled cushion 200 can grow on the X and Y axes, being restricted in such growth due to the flexible mask body 100 it is coupled to. The flexibility of the mask body 100 allows the mask body 100 to reduce in the X axis as headgear tension is applied. The convex portion 202 keeps tension on the area below the mentolabial crease, allowing for the dimension between bottom of chin to top of bridge to be reduced by the dimension h as shown in FIG. 5. h will vary among sizes of the mask body 100 and fluid-filled cushion 200. The make-up of the fluid-filled cushion 200, as described herein, permits the fluid-filled cushion 200 to stretch substantially. As the user talks, the convex portion 202 acts as a tension lever, thereby stretching this area. The convex portion 202 maintains tension so the seal is not broken between the fluid-filled cushion 200 and the user's face.

### Further Definitions and Construction of Terms

The titles, headings, and subheadings provided herein should not be interpreted as limiting the various aspects of the disclosure. Accordingly, the terms defined herein are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities, and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

As used herein, the term “about,” means approximately. When the term “about” is used in conjunction with a numerical range, it modifies that range by extending the boundaries above and below the numerical values set forth. Illustratively, the use of the term “about” indicates that values slightly outside the cited values (e.g., plus or minus 0.1% to 10%), which are also effective and safe are included in the value. Numerical ranges recited herein by endpoints include all numbers and fractions subsumed within that range (e.g., 1 to 5 includes 1, 1.5, 2, 2.75, 3, 3.90, 4, and 5).

As used herein, the terms “comprising” (and any form of comprising, such as “comprise,” “comprises,” and “comprised”), “having” (and any form of having, such as “have” and “has”), “including” (and any form of including, such as “includes” and “include”), and “containing” (and any form of containing, such as “contains” and “contain”) are inclusive or open-ended, and do not exclude additional, un-recited elements or method steps. Additionally, a term that is used in conjunction with the term “comprising” is also understood to be able to be used in conjunction with the term “consisting of” or “consisting essentially of.”

Method steps described in this disclosure can be performed in any order unless otherwise indicated or otherwise clearly contradicted by context.

For the avoidance of doubt, insofar as is practicable, any embodiment of a given aspect of the present disclosure may occur in combination with any other embodiment of the same aspect of the present disclosure. In addition, insofar as is practicable, it is to be understood that any preferred or optional embodiment of any aspect of the present disclosure should also be considered as a preferred or optional embodiment of any other aspect of the present disclosure.

1. A cushion of a facemask comprising:
a perimeter sealing portion configured to make a perimeter seal above a mentolabial crease of a user; and
a convex portion extending from a bottom portion of the cushion and partway to a top portion of the cushion, wherein the convex portion is configured to contact a user's chin, below the mentolabial crease, and facilitate a surface seal between the cushion and the user's face.

2. The cushion of claim 1, further comprising a bottom portion configured to extend below the user's chin.

3. The cushion of claim 1, wherein the convex portion has a height of about 0.6 inches to about 0.9 inches.

4. The cushion of claim 1, wherein the convex portion has a vertical height that is a maximum of about 40% of the distance between bottom and top portions of the cushion.

5. The cushion of claim 4, wherein the convex portion has a vertical height that is a maximum of about 20% of the distance between the bottom and top portions of the cushion.

6. The cushion of claim 1, wherein the convex portion has a vertical height that is a minimum of about 12% of the distance between bottom and top portions of the cushion.

7. The cushion of claim 6, wherein the convex portion has a vertical height that is a minimum of about 25% of the distance between the bottom and top portions of the cushion.

8. The cushion of claim 1, wherein the convex portion extends substantially parallel to a plane, formed from a cushion attachment surface of a mask body of a facemask, when the facemask is not in use.

9. The cushion of claim 1, wherein the convex portion is configured to bend and extend away from a plane, formed from a cushion attachment surface of a mask body of a facemask, when convex portion is acted upon by the user's chin, wherein the bending of the convex portion facilitates creation and maintenance of the surface seal between the cushion and the user's face.

10. The cushion of claim 9, wherein the convex portion is configured to bend up to perpendicular with respect to the plane.

11. The cushion of claim 1, wherein the convex portion extends substantially parallel to a cross-section of a flexible rim, of a mask body of a facemask, when the facemask is not in use.

12. The cushion of claim 1, wherein the convex portion is configured to bend and extend away from parallel with respect to a cross-section of a flexible rim, of a mask body of a facemask, as the convex portion is acted upon by the user's chin, wherein the bending of the convex portion facilitates creation and maintenance of the surface seal between the cushion and the user's face.

13. The cushion of claim 12, wherein the convex portion is configured to bend up to perpendicular with respect to the cross-section of the flexible rim.

14. The cushion of claim 1, wherein the convex portion is configured to bend and extend toward a front of a mask body of a facemask as the convex portion is acted upon by the user's chin, wherein the bending of the convex portion facilitates creation and maintenance of the surface seal between the cushion and the user's face.

15. The cushion of claim 1, wherein the convex portion is configured to bend and extend into a cavity of a mask body of a facemask as the convex portion is acted upon by the user's chin, wherein the bending of the convex portion facilitates creation and maintenance of the surface seal between the cushion and the user's face.

16. A facemask comprising:
a mask body comprising a cushion attachment surface and a flexible rim, wherein the flexible rim extends inwardly away from the cushion attachment surface, and wherein the mask body is flexible and resilient;
the cushion of claim 1 coupled to the cushion attachment surface;
a filter; and
a filter support structure coupled to the filter and the flexible rim, wherein the filter support structure is configured to engage the filter with the flexible rim to create an airtight seal between the filter and the flexible rim.

17. The facemask of claim 16, wherein:
the flexible rim is inwardly biased; and
the filter support structure is outwardly biased.

18. The facemask of claim 16, wherein the filter support structure comprises support elements.

19. The facemask of claim 18, wherein the support elements are configured as a lattice.

20. The facemask of claim 16, wherein the convex portion of the cushion facilitates the airtight seal, between the cushion and the user's face, when a length, from the user's chin to the bridge of the user's nose, is less than a length from the top to the bottom of the mask body.

21. The facemask of claim 16, wherein:
the filter comprises apertures; and
the filter support structure comprises extension elements, wherein the extension elements extend through the apertures to engage the filter against the filter support structure.

22. The facemask of claim 21, wherein each of the apertures is located proximate to a continuous perimeter edge of the filter.

23. The facemask of claim 21, wherein the extension elements extend outwardly through the apertures of the filter.

24. The facemask of claim 21, wherein:
the filter support structure comprises a continuous back perimeter; and
the extension elements extend outwardly from the continuous back perimeter.

25. The facemask of claim 24, wherein:
the continuous back perimeter forms a plane of the filter support element; and
the extension elements extend outwardly along the plane of the filter support element.

26. The facemask of claim 21, wherein:
the flexible rim comprises apertures; and
the extension elements extend through the apertures of the flexible rim after the extension elements extend through the apertures of the filter, thereby contacting the filter with the flexible rim to create the airtight seal between the filter and the flexible rim.

27. The facemask of claim 26, wherein the extension elements extend outwardly through the apertures of the flexible rim.

28. The facemask of claim 16, wherein the filter support structure has a convex surface configured for placement against and at least substantially corresponding to an inner concave surface of the filter.

29. The facemask of claim 16, wherein:
the filter is permanently coupled to the filter support structure; and
the airtight seal, between the filter and the flexible rim, is established by direct friction fitting the filter to the flexible rim.

30. The facemask of claim 29, wherein the filter is permanently coupled to the filter support structure using at least one of adhesion, welding, and crimping.

31. The facemask of claim 29, wherein an inner portion of the filter, proximate a perimeter edge of the filter, is permanently coupled to an outer surface of the filter support structure.

32. The facemask of claim 29, wherein the airtight seal, between the filter and the flexible rim, is further established by direct friction fitting the filter support structure to the flexible rim.

33. The facemask of claim 29, wherein:
the flexible rim is inwardly angled and biased; and
an external edge portion, of the filter, is outwardly biased and directly friction fit against an inner surface of the flexible rim.

34. The facemask of claim 16, wherein:
the filter support structure has a continuous channel;
an o-ring secures a portion of the filter within the channel; and
the airtight seal, between the filter and the flexible rim, is established by direct friction fitting the filter to the flexible rim.

35. The facemask of claim 34, wherein the airtight seal, between the filter and the flexible rim, is further established by direct friction fitting the filter support structure to the flexible rim.

36. The facemask of claim 34, wherein:
the flexible rim is inwardly angled and biased; and
an external edge portion, of the filter, is outwardly biased and directly friction fit against an inner surface of the flexible rim.

37. A facemask comprising:
a mask body comprising a cushion attachment surface and a flexible rim, wherein the flexible rim extends inwardly away from the cushion attachment surface, and wherein the mask body is flexible and resilient;
the cushion of claim 1 coupled to the cushion attachment surface;
at least one of a filter cartridge and a filter; and
a housing removably coupled to the mask body via direct friction fitting that produces an airtight seal between the mask body and the housing, the housing comprising a filtration media coupler configured to removably receive and couple to the at least one of the filter cartridge and the filter.

38. The facemask of claim 37, wherein:
the flexible rim is inwardly angled and biased; and
an external edge portion, of the housing, is outwardly biased and directly friction fit against an inner surface of the flexible rim.

39. The facemask of claim 37, wherein the housing comprises an aperture configured to permit ingress and egress of air into and from a breathing chamber of the facemask.

40. The facemask of claim 37, wherein the housing comprises:
a one-way value configured to permit air to ingress into a breathing chamber of the facemask via the at least one of the filter cartridge and the filter; and
one or more one-way values configured to allow air to egress from the breathing chamber.

41. The facemask of claim 37, wherein:
the housing comprises a port configured to permit ingress, and optionally egress, of air into, and optionally from, a breathing chamber of the facemask;
the facemask comprises both the filter cartridge and the filter; and
the filter is positioned within the filtration media coupler between the filter cartridge and the port.

42. The facemask of claim 41, wherein the facemask further comprises a filter holder positioned between the filter and the port.

43. The facemask of claim 37, wherein:
the housing comprises a port configured to permit ingress, and optionally egress, of air into, and optionally from, a breathing chamber of the facemask;
the facemask comprises the filter but the filter cartridge; and
the facemask further comprises a filter retaining element removably coupled to the filtration media coupler,
wherein the filter is positioned within the filtration media coupler between the filter retaining element and the port.

44. The facemask of claim 43, wherein the facemask further comprises a filter holder positioned between the filter and the port.

45. A kit comprising:
a mask body comprising a cushion attachment surface and a flexible rim, wherein the mask body is flexible and resilient, the flexible rim extends inwardly away from the cushion attachment surface, the flexible rim has apertures, the mask body has the cushion of claim 1 coupled to the cushion attachment surface;
a filter having apertures; and
a filter support structure having extension elements and configured to be removably coupled to the filter and the flexible rim by:
extending the extension elements through the apertures of the filter, thereby removably coupling the filter to the filter support structure; and
after extending the extension elements through the apertures of the filter, extending the extension elements through the apertures of the flexible rim, thereby engaging the filter with the flexible rim to create an airtight seal between the filter and the flexible rim.

46. The kit of claim 45, wherein:
the flexible rim is inwardly biased; and
the filter support structure is outwardly biased.

47. The kit of claim 45, wherein the filter support structure comprises support elements.

48. The kit of claim 47, wherein the support elements are configured as a lattice.

49. The kit of claim 45, wherein each of the apertures of the filter is located proximate to a continuous perimeter edge of the filter.

50. The kit of claim 45, wherein the extension elements are configured to extend outwardly through the apertures of the filter.

51. The kit of claim 45, wherein:
the filter support structure comprises a continuous back perimeter; and
the extension elements extend outwardly from the continuous back perimeter.

52. The kit of claim 51, wherein:
the continuous back perimeter forms a plane of the filter support structure; and
the extension elements extend outwardly along the plane of the filter support structure.

53. The kit of claim 45, wherein the extension elements are configured to extend outwardly through the apertures of the flexible rim.

54. The kit of claim 45, wherein the filter support structure has a convex surface configured for placement against and at least substantially corresponding to an inner concave surface of the filter.

55. (canceled)

56. A kit comprising:
a mask body comprising a cushion attachment surface and a flexible rim, wherein the mask body is flexible and resilient, the flexible rim extends inwardly away from the cushion attachment surface, the mask body has the cushion of claim 1 coupled to the cushion attachment surface; and
a filter assembly comprising a filter permanently coupled to a filter support structure, wherein the filter assembly is configured to removably couple the filter to the flexible rim by direct friction fitting the filter against the flexible rim, thereby engaging the filter with the flexible rim to create an airtight seal between the filter and the flexible rim.

57. The kit of claim 56, wherein:
the flexible rim is inwardly biased; and
the filter support structure is outwardly biased.

58. The kit of claim 56, wherein the filter support structure has a convex surface placed against and at least substantially corresponding to an inner concave surface of the filter.

59. The kit of claim 56, wherein the filter is permanently coupled to the filter support structure using at least one of adhesion, welding, and crimping.

60. The kit of claim 56, wherein an inner portion of the filter, proximate a perimeter edge of the filter, is permanently coupled to an outer surface of the filter support structure.

61. The kit of claim 56, wherein the airtight seal, between the filter and the flexible rim, is further established by direct friction fitting the filter support structure to the flexible rim.

62. The kit of claim 56, wherein:
the flexible rim is inwardly angled and biased; and
an external edge portion, of the filter, is outwardly biased and directly friction fit against an inner surface of the flexible rim.

63.-66. (canceled)
